(19) United States
(12) Patent Application Publication
(10) Pub. No.: US 2010/0062840 A1
(43) Pub. Date: Mar. 11, 2010

(54) SYSTEM AND METHOD FOR SOCIAL NETWORKING IN A GAMING ENVIRONMENT

(76) Inventor: Mark E. Herrmann, Wellesley, MA (US)

Correspondence Address: LANDO & ANASTASI, LLP, ONE MAIN STREET, SUITE 1100, CAMBRIDGE, MA, 02142, US

(21) Appl. No.: 12/495,156

(22) Filed: Jun. 30, 2009

Related U.S. Application Data
(60) Provisional application No. 61/076,918, filed on Jun. 30, 2008.

(51) Int. Cl. G06F 17/00

(52) U.S. Cl. 463/25; 463/42; 463/43

(57) ABSTRACT

Social networking functions may be provided in systems implemented in a gaming setting which uses information relating to players. In one implementation, a social network is provided that revolves around real-world gaming that takes place within a lawful gaming establishment. Gaming establishments accept wagers from players to play different types of games, including pure games of chance (e.g., video slots, video poker, etc.), table games, and other games involving various levels of skill. Because social networks are not designed for the gaming experience, one that integrates with the gaming and environment provides many benefits to both the player and the gaming establishment. In some implementations, such a social network may encompass the casino management network (e.g., a server-based gaming system), the players' computer at home, a mobile device (e.g., a PDA, cell phone, etc.) and/or any other Internet-enabled device.

### RELATED APPLICATIONS

This application claims priority under 35 U.S.C. § 119(e) to U.S. Provisional Application Ser. No. 61/076,918, entitled “SYSTEM AND METHOD FOR SOCIAL NETWORKING IN A GAMING ENVIRONMENT,” filed on Jun. 30, 2008, which is herein incorporated by reference in its entirety.

### APPLICABLE FIELD

The applicable field relates to gaming, and more particularly, to systems and methods for communicating in a gaming setting.

### BACKGROUND

Social networks in different forms have become more popular, with most of them being slight variations on the well-known MySpace (http://www.myspace.com) or Facebook (http://www.facebook.com) models. Such tools are generally used to post information that can be accessed by other registered users of the system. Unfortunately, the trend of social networking tools has solidified the notion of social networks as a web-page only paradigm, a virtual Rolodex that grows so big that the social network lacks context, and hence relevance.

### SUMMARY

According to one aspect of the present invention, it is appreciated that social networking functions may be beneficial in a gaming setting. In one implementation, a social network is provided that revolves around real-world gaming that takes place within a lawful gaming establishment. Gaming establishments accept wagers from players to play different types of games, including pure games of chance (e.g., video slots, video poker, etc.), table games, and other games involving various levels of skill.

Because social networks are not designed for the gaming experience, one that integrates with the gaming and environment provides many benefits to both the player and the gaming establishment. In some implementations, such a social network may encompass the casino management network (e.g., a server-based gaming system), the players' computer at home, a mobile device (e.g., a PDA, cell phone, etc.) and/or any other Internet-enabled or other communication-capable device. In yet another embodiment, social networking functions may be provided for lottery-based systems and patrons of various lottery products.

According to another embodiment, such a system may qualify players and may provide social networking features that are responsive to such a qualification. For instance, the player may be qualified through an existing loyalty club or other frequent player program type. In one implementation, qualified players include those who have chosen to join a particular gaming establishment's player loyalty club. A gaming establishment may include, for example, any location where lawful gaming is permitted to occur. In another example, such a system may require that a player retain a certain status (e.g., gamble a particular rate) in order to retain their qualified status which would allow the player to participate in a social network.

Various types of social networking functions may be advantageous, especially in a gaming environment. For instance, it may be beneficial to be able to locate and identify other players within the gaming location. In one example, a person may wish to know when a friend or family member is at a casino location, and where that person is located on the casino floor. In yet another example, player can view and comment on content created by other players in real time (or near-real time) within the gaming environment, which may lead to players enhancing (and extending) their gaming experience.

In another example, it may be beneficial to know, on a computer system, when and what a player is doing on the casino floor. In one example, a person located outside the gaming location (e.g., operating a home computer) may view the status of a player inside the gaming location. In another example, a person located outside of the gaming location may be permitted to interact with the player inside the gaming location. In yet another example, a player may be permitted to view play of a player for the purpose of learning how to play a particular game. The player may also be permitted to “play along” with other players in the gaming location.

In another example, players located at different gaming facilities may be permitted to communicate using social networking tools. For instance, players at different gaming locations (e.g., players at affiliated gaming facilities) may use such tools to communicate and perform various functions as discussed herein among a number of facilities.

In another implementation, the social network may permit players to create a related gaming experience to events that occur on the casino floor. For instance, the social network itself may be permitted to accept wagers made between players, and some of those wagers may relate to real-world events that occur within the casino or other type of gaming establishment. For example, one or more players interacting in the social network may be permitted to place wagers or take bets from other players on a potential outcome of a game being played on the casino floor (e.g., betting whether there will be a “seven” rolled on the next roll of a craps game). To this end, a secondary market for wagering may be created and supported by the social network. There are many other examples where location information may be useful for enhancing the gaming experience.

In another implementation, players may be permitted to organize multiplayer games within the gaming location using one or more social networking tools. In one example, a player at a slot machine may be provided social networking tools that permit the player to organize his/her own slot tournament. For instance, the player, through an interface of a gaming terminal, may communicate to other players (for instance, their “friends”) at other terminals to begin a slot tournament. By providing the player the ability to customize their gaming experience with other players, the opportunity to maintain the interest of the player is increased.

According to one aspect of the present invention, a method for conducting a computer-based game in a legal gaming location is provided. The method comprises acts of providing, at a terminal associated with a server-based gaming system, at least one game that may be played by a player in the legal gaming location, and providing, at the terminal associated with the server-based gaming system, at least one social networking function that presents, to the player, information relating to a plurality of players located at the legal gaming location. According to one embodiment of the present invention, the method further comprises an act of indicating to the player, a location of at least one of the plurality of players at the legal gaming location. According to another embodiment of the invention, the method further comprises an act of indicating to the player, a map of the gaming location, and indicating a presence of at least one of the plurality of players on the map of the gaming location. According to another embodiment of the invention, the at least one social networking function comprises a chat function, a wiki function, a blogging function, a player search function, an opinion polling function, a messaging function, and a file sharing function. According to another embodiment of the invention, the method further comprises an act of determining a location of the player based on an act performed by the player within the legal gaming location.

According to one embodiment of the present invention, the method further comprises an act of determining, by the server-based gaming system, the location of the player based on the act which is performed at a terminal of the server-based gaming system. According to another embodiment of the invention, the method further comprises an act of displaying, to the player at the terminal associated with the server-based gaming system, information shared among the plurality of players. According to another embodiment of the invention, the method further comprises an act of providing, to the player at the terminal associated with the server-based gaming system, a control that permits the player to create a group of associations with other players. According to another embodiment of the invention, the method further comprises an act of providing, to the player at the terminal associated with the server-based gaming system, a control that permits a player to search for other players based on a set of criteria provided by the player. According to another embodiment of the invention, the method further comprises an act of providing, to the player at the terminal associated with the server-based gaming system, a control that permits at least two players to locate each other based on criteria provided by both of the at least two players.

According to one embodiment of the present invention, the method further comprises an act of providing, to the player at the terminal associated with the server-based gaming system, an advertisement based on an action performed by the player responsive to the provided at least one social networking function. According to another embodiment of the invention, the terminal associated with the server-based gaming system is adapted to accept a wager from the player to play a wagering game. According to another embodiment of the invention, the method further comprises an act of compiling information provided by players by the at least one social networking function, and presenting the compiled information to the player at the terminal associated with the server-based gaming system. According to another embodiment of the invention, the method further comprises an act of presenting the information to a user of a computer system coupled to the server-based gaming system through a communication network. According to another embodiment of the invention, the computer system comprises a general purpose computer system. According to another embodiment of the invention, the legal gaming location includes a physical gaming location comprising at least one of a casino, a racino, a dog-racing track, a horse-racing track, a point-of-sale location, a riverboat, a legal gaming site, a lottery retailer, an off-track betting facility, a sports betting parlor, and a parlor that offers amusements with prizes.

According to one embodiment of the present invention, the method further comprises an act of qualifying the player by the server-based gaming system, and providing the at least one social networking function responsive to the qualification. According to another embodiment of the invention, the method further comprises an act of permitting at least two players to make a wager with each other using the at least one social networking function. According to another embodiment of the invention, the server-based gaming system is configured to arbitrate a wager between at least two players using the at least one social networking function. According to another embodiment of the invention, the method further comprises an act of displaying the information relating to a plurality of players located at the legal gaming location during play of the at least one game by the player in the legal gaming location. According to another embodiment of the invention, the method further comprises an act of providing, to the player at the terminal associated with the server-based gaming system, an advertisement based on an interaction between at least two players using the provided at least one social networking function. According to another embodiment of the invention, the method further comprises presenting, to at least one other player in another terminal associated with the server-based gaming system, a personal user profile of the player. According to another embodiment of the invention, the personal user profile of the player includes content provided by the player, and wherein the method comprises displaying, to the at least one other player, the provided content.

According to one embodiment of the present invention, the method further comprises an act of permitting the player to selectively share the personal user profile with one or more other players. According to another embodiment of the invention, the method further comprises an act of storing, in the personal user profile of the player, one or more content items provided by the server-based gaming system. According to another embodiment of the invention, the method further comprises an act of providing, at a computer system located outside of the legal gaming location, access to a social networking function that permits communication with a plurality of players in the legal gaming location. According to another embodiment of the invention, the method further comprises an act of providing, at a computer system located outside of the legal gaming location, access to a social networking function that permits a person operating the computer system to view a status of the player located in the legal gaming location. According to another embodiment of the invention, the method further comprises an act of permitting the player and at least one other player to transfer items using the social networking tool. According to another embodiment of the invention, the items include at least one of a group comprising credits, non-cashable credits, frequent player program points, and cash.

According to one aspect of the present invention, a computer-readable medium having computer-readable signals stored thereon that define instructions that, as a result of being executed by a computer, instruct the computer to perform a method for conducting a computer-based game in a legal gaming location is provided. The method comprises acts of providing, at a terminal associated with a server-based gaming system, at least one game that may be played by a player in the legal gaming location, and providing, at the terminal associated with the server-based gaming system, at least one social networking function that presents, to the player, information relating to a plurality of players located at the legal gaming location. According to one embodiment of the present invention, the computer readable medium further comprises an act of indicating to the player, a location of at least one of the plurality of players at the legal gaming location. According to another embodiment of the invention, the computer readable medium further comprises an act of indicating to the player, a map of the gaming location, and indicating a presence of at least one of the plurality of players on the map of the gaming location. According to another embodiment of the invention, the at least one social networking function comprises a chat function, a wild function, a blogging function, a player search function, an opinion polling function, a messaging function, and a file sharing function.

According to one embodiment of the present invention, the computer readable medium further comprises an act of determining a location of the player based on an act performed by the player within the legal gaming location. According to another embodiment of the invention, the computer readable medium further comprises an act of determining, by the server-based gaming system, the location of the player based on the act which is performed at a terminal of the server-based gaming system. According to another embodiment of the invention, the computer readable medium further comprises an act of displaying, to the player at the terminal associated with the server-based gaming system, information shared among the plurality of players. According to another embodiment of the invention, the computer readable medium further comprises an act of providing, to the player at the terminal associated with the server-based gaming system, a control that permits the player to create a group of associations with other players. According to another embodiment of the invention, the computer readable medium further comprises an act of providing, to the player at the terminal associated with the server-based gaming system, a control that permits a player to search for other players based on a set of criteria provided by the player. According to another embodiment of the invention, the computer readable medium further comprises an act of providing, to the player at the terminal associated with the server-based gaming system, a control that permits at least two players to locate each other based on criteria provided by both of the at least two players.

According to one embodiment of the present invention, the computer readable medium further comprises an act of providing, to the player at the terminal associated with the server-based gaming system, an advertisement based on an action performed by the player responsive to the provided at least one social networking function. According to another embodiment of the invention, the terminal associated with the server-based gaming system is adapted to accept a wager from the player to play a wagering game. According to another embodiment of the invention, the computer readable medium further comprises an act of compiling information provided by players by the at least one social networking function, and presenting the compiled information to the player at the terminal associated with the server-based gaming system. According to another embodiment of the invention, the computer readable medium further comprises an act of presenting the information to a user of a computer system coupled to the server-based gaming system through a communication network. According to another embodiment of the invention, the computer system comprises a general purpose computer system. According to another embodiment of the invention, the legal gaming location includes a physical gaming location comprising at least one of a casino, a racino, a dog-racing track, a horse-racing track, a point-of-sale location, a riverboat, and a legal gaming site, a lottery retailer, an off-track betting facility, a sports betting parlor, and a parlor that offers amusements with prizes.

According to one embodiment of the present invention, the computer readable medium further comprises an act of qualifying the player by the server-based gaming system, and providing the at least one social networking function responsive to the qualification. According to another embodiment of the invention, the computer readable medium further comprises an act of permitting at least two players to make a wager with each other using the at least one social networking function. According to another embodiment of the invention, the server-based gaming system is configured to arbitrate a wager between at least two players using the at least one social networking function. According to another embodiment of the invention, the computer readable medium further comprises an act of displaying the information relating to a plurality of players located at the legal gaming location during play of the at least one game by the player in the legal gaming location. According to another embodiment of the invention, the computer readable medium further comprises an act of providing, to the player at the terminal associated with the server-based gaming system, an advertisement based on an interaction between at least two players using the provided at least one social networking function. According to another embodiment of the invention, the computer readable medium further comprises presenting, to at least one other player in another terminal associated with the server-based gaming system, a personal user profile of the player. According to another embodiment of the invention, the personal user profile of the player includes content provided by the player, and wherein the method comprises displaying, to the at least one other player, the provided content.

According to one embodiment of the present invention, the computer readable medium further comprises an act of permitting the player to selectively share the personal user profile with one or more other players. According to another embodiment of the invention, the computer readable medium further comprises an act of storing, in the personal user profile of the player, one or more content items provided by the server-based gaming system. According to another embodiment of the invention, the computer readable medium further comprises an act of providing, at a computer system located outside of the legal gaming location, access to a social networking function that permits communication with a plurality of players in the legal gaming location. According to another embodiment of the invention, the computer readable medium further comprises an act of providing, at a computer system located outside of the legal gaming location, access to a social networking function that permits a person operating the computer system to view a status of the player located in the legal gaming location. According to another embodiment of the invention, the computer readable medium further comprises an act of permitting the player and at least one other player to transfer items using the social networking tool. According to another embodiment of the invention, the items include at least one of a group comprising credits, non-cashable credits, frequent player program points, and cash.

According to one aspect of the present invention, a server-based game system comprises at least one server-based system configured to execute one or more game programs and is configured to provide at least one social networking function that presents information relating to a plurality of players located at a legal gaming location, and a terminal configured to display at least one game that is adapted to be played by a player within the legal gaming location, the terminal being configured to display the information relating to the plurality of players. According to one embodiment of the present invention, the system further comprises a component adapted to indicate to the player, a location of at least one of the plurality of players at the legal gaming location. According to another embodiment of the invention, the system further comprises a component adapted to indicate to the player, a map of the gaming location, and indicating a presence of at least one of the plurality of players on the map of the gaming location. According to another embodiment of the invention, the at least one social networking function comprises a chat function, a wiki function, a blogging function, a player search function, an opinion polling function, a messaging function, and a file sharing function. According to another embodiment of the invention, the system further comprises a component adapted to determine a location of the player based on an act performed by the player within the legal gaming location.

According to one embodiment of the present invention, the system further comprises a component adapted to determine, by the server-based gaming system, the location of the player based on the act which is performed at a terminal of the server-based gaming system. According to another embodiment of the invention, the system further comprises a component adapted to display, to the player at the terminal associated with the server-based gaming system, information shared among the plurality of players. According to another embodiment of the invention, the system further comprises a component adapted to provide, to the player at the terminal associated with the server-based gaming system, a control that permits the player to create a group of associations with other players. According to another embodiment of the invention, the system further comprises a component adapted to provide, to the player at the terminal associated with the server-based gaming system, a control that permits a player to search for other players based on a set of criteria provided by the player. According to another embodiment of the invention, the system further comprises a component adapted to provide, to the player at the terminal associated with the server-based gaming system, a control that permits at least two players to locate each other based on criteria provided by both of the at least two players.

According to one embodiment of the present invention, the system further comprises a component adapted to provide, to the player at the terminal associated with the server-based gaming system, an advertisement based on an action performed by the player responsive to the provided at least one social networking function. According to another embodiment of the invention, the terminal associated with the server-based gaming system is adapted to accept a wager from the player to play a wagering game. According to another embodiment of the invention, the system further comprises a component adapted to compile information provided by players by the at least one social networking function, and presenting the compiled information to the player at the terminal associated with the server-based gaming system. According to another embodiment of the invention, the system further comprises a component adapted to present the information to a user of a computer system coupled to the server-based gaming system through a communication network. According to another embodiment of the invention, the computer system comprises a general purpose computer system. According to another embodiment of the invention, the legal gaming location includes a physical gaming location comprising at least one of a casino, a racino, a dog-racing track, a horse-racing track, a point-of-sale location, a riverboat, and a legal gaming site, a lottery retailer, an off-track betting facility, a sports betting parlor, and a parlor that offers amusements with prizes.

According to one embodiment of the present invention, the system further comprises a component adapted to qualify the player by the server-based gaming system, and providing the at least one social networking function responsive to the qualification. According to another embodiment of the invention, the system further comprises a component adapted to permit at least two players to make a wager with each other using the at least one social networking function. According to another embodiment of the invention, the server-based gaming system is configured to arbitrate a wager between at least two players using the at least one social networking function. According to another embodiment of the invention, the system further comprises a component adapted to display the information relating to a plurality of players located at the legal gaming location during play of the at least one game by the player in the legal gaming location. According to another embodiment of the invention, the system further comprises a component adapted to provide, to the player at the terminal associated with the server-based gaming system, an advertisement based on an interaction between at least two players using the provided at least one social networking function. According to another embodiment of the invention, the system further comprises a component adapted to present, to at least one other player in another terminal associated with the server-based gaming system, a personal user profile of the player. According to another embodiment of the invention, the personal user profile of the player includes content provided by the player, and wherein the method comprises displaying, to the at least one other player, the provided content. According to another embodiment of the invention, the system further comprises a component adapted to permit the player to selectively share the personal user profile with one or more other players. According to another embodiment of the invention, the system further comprises a component adapted to store, in the personal user profile of the player, one or more content items provided by the server-based gaming system. According to another embodiment of the invention, the system further comprises a component adapted to provide, at a computer system located outside of the legal gaming location, access to a social networking function that permits communication with a plurality of players in the legal gaming location.

According to another embodiment of the invention, the system further comprises a component adapted to provide, at a computer system located outside of the legal gaming location, access to a social networking function that permits a person operating the computer system to view a status of the player located in the legal gaming location. According to another embodiment of the invention, the system further comprises a component adapted to permit the player and at least one other player to transfer items using the social networking tool. According to another embodiment of the invention, the items include at least one of a group comprising credits, non-cashable credits, frequent player program points, and cash.

Further features and advantages as well as the structure and operation of various embodiments are described in detail below with reference to the accompanying drawings. In the drawings, like reference numerals indicate like or functionally similar elements. Additionally, the left-most one or two digits of a reference numeral identifies the drawing in which the reference numeral first appears.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates an example computer system upon which various aspects in accord with the present invention may be implemented;

FIG. 2 shows an example system architecture of a server-based gaming system according to various aspects in accordance with the present invention;

FIG. 3 shows an example process that may be used to implement social networking features by a server-based gaming system;

FIG. 4 shows an example process for event betting according to one embodiment;

FIG. 5 shows an example process according to one embodiment wherein actions performed by players at the gambling location may be used to trigger advertisements that are displayed to players;

FIGS. 6A-6B show example interfaces that may be used to display social networking functions in accordance with various embodiments;

FIG. 7 shows a process of attracting players in accordance with various embodiments of the present invention;

FIG. 8 shows an environment suitable for implementing various aspects of the present invention;

FIG. 9 shows another environment suitable for implementing various aspects of the present invention;

FIG. 10 shows a general-purpose computer system suitable for implementing various aspects of the present invention; and

FIG. 11 shows a storage system suitable for implementing various aspects of the present invention.

### DETAILED DESCRIPTION

The aspects disclosed herein, which are in accord with the present invention, are not limited in their application to the details of construction and the arrangement of components set forth in the following description or illustrated in the drawings. These aspects are capable of assuming other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

For example, according to various embodiments of the present invention, a computer system is configured to perform any of the functions described herein, including but not limited to, performing social networking functions within a gaming setting. However, such a system may also perform other functions. Moreover, the systems described herein may be configured to include or exclude any of the functions discussed herein. Thus the invention is not limited to a specific function or set of functions. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items.

### Example Features of a Gaming-Related Social Network

Such a social network may be provided in a lawful gaming establishment using one or more systems of the establishment, including, but not limited to, casino management systems, kiosks located in the gaming establishment, typical gaming machines, electronic gaming machines (EGMs) such as, for example, a slot management system, portable gaming devices used on the gaming floor, and any other system that performs gaming functions. According to one aspect, players are permitted to perform social networking functions while located within the gaming establishment. For instance, players may be permitted to interact and view status information relating to social networking functions within the gaming establishment, such as on a display of a gaming machine (e.g., in a window displayed at a player terminal) or other system used for making wagers. This may permit, for example, players to interact in near-real time on the gaming floor of a casino floor. For instance, people may interact in various ways, including communicating in near-real time, sharing content, making wagers between players in the social network, trading and/or sharing credits, frequent player points, cash, and similar items. Because such interaction is permitted, the gaming experience is enhanced for the player, and the gaming establishment is more likely to attract and retain the player. In one implementation, such social networking functions may be implemented in a server-based gaming system operated by the gaming establishment.

Also, it is appreciated that some social networking functions may be implemented in other systems, including, but not limited to a person's computer, PDA, cell phone or other device configured to communicate with other players in the gaming environment. For example, such systems may communicate with other player devices over any number of public and/or private communication networks, including the Internet. These systems may also be coupled to systems operated by the gaming establishment, such as a server-based gaming system as discussed above.

In one example, persons located outside of the gaming location may be permitted to view the status of players and/or events inside the gaming location, thus providing a connection with people and activities occurring there. For instance, a person using a personal computer at a location outside of the gaming facility may be permitted to view the status of a player's play within the facility, view leader boards, progressive slots displays, the status of games of skill being played in the facility, or other activity relating to gaming The person outside the gaming facility may also be provided the ability to interact with players using one or more social networking tools as discussed above. In one example, a person located outside the gaming facility may be permitted to loan credits, frequent player points, money, bonus points, or other item having value with a player located in the casino. Thereafter, the player may be permitted to use the item to purchase goods or services (e.g., play games) within the gaming facility.

In another example, people may be able to monitor the status and/or otherwise communicate with people in a real-time manner within the casino or other gaming facility. For instance, one social networking function may include a Twitter-like functionality where the system allows the individual to send personal “tweets” or the system can be set to make automated “tweets” upon hitting a certain criteria. For instance, a “tweet” or other type of message may be send upon the detection of certain conditions (e.g., a person arrives at a casino as measured, for example, by a swipe at a kiosk located at or near a front desk, or a person performs a first action in the casino anywhere, thus placing the person at the casino location). In another example, an action that causes a communication to be sent may include the person/player winning a certain jackpot/amount, playing at new machine, or other condition. Users outside of the casino may subscribe to receive messages from that person, especially when they interact with the gaming location or other system associated with the gaming location.

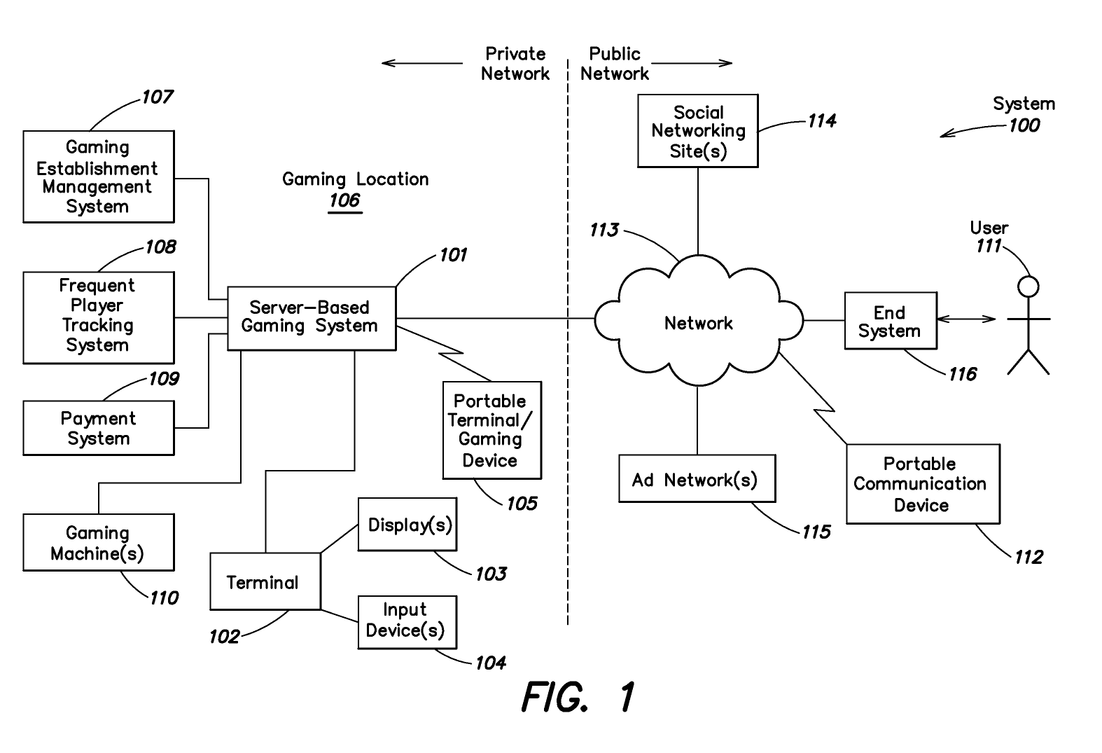

According to one aspect, social networking functions may be implemented on a server-based gaming system such as the server-based gaming system (e.g., server-based gaming system 101) shown by way of example in FIG. 1. Generally, such systems may be used for playing multiple types of games within a gaming location on a number of terminals. Instead of having individual gaming machines that are separately managed and maintained, gaming locations use server-based gaming systems that are more flexible in the types of games that are supported on them as well as the maintenance and cost of such systems.

Games that may benefit by such social networking functions include any type of game offered in the gaming location including, but not limited to, games of chance, games of skill and chance, table-based games (e.g., poker, roulette, blackjack), card-based games such as video poker, video slot machines, among others. In one example implementation, players may be permitted to use various social networking features depending on the games they are playing, and the type of access that can be provided.

In one example implementation, it is appreciated that information may be communicated to/from table games. As table games such as poker, blackjack and roulette become more automated, information may be shared between players of these types of games. Data created through play of such games may be downloaded and displayed to players inside the gaming location or to persons located outside the gaming location. For instance, such data may be used to replay actual table game play at a later time (e.g., to perform strategy analysis, perform training, replay a player's own play with friends within a social networking tool, etc.). Other types of games such as video poker may provide data to the social network that can be viewed and shared with other players.

Another social networking function that may be useful in a gaming setting may include permitting a player to set up wagering games between himself/herself and other people. In another example, other community-type gaming games may benefit by having social networking functions. For instance, slot tournaments, multi-player bonus rounds, and other community-based games offered within the casino location may be provided social networking functions according to various embodiments. According to one embodiment, a player may be permitted to set up their own slot tournament (e.g., with just your friends in the player's network). In another example, a player may be permitted to connect his/her slot machine that they are currently using with friends playing another slot machine (e.g., of the same type), but in a different bank of machines. For instance, this may permit the players in the social network to all enter the same bonus round. Thus, the player can play convention machines with their social network in a more flexible way, without the typical machine-based limitations currently present in conventional gaming locations. Other social networking functions may permit, for example, a player to set up a leaderboard among people in their social network (e.g., their friends), set up one or more progressive jackpots among people in their social network, or other organization of gaming activities or sharing of information within the player's social network.

Further, such monitoring and sharing of information may be useful for other entities not within the social network of the player. For instance, information shared within the social network by advertisers may be useful to provide offers to those players (e.g., for a defined social group, monitor all members of the defined social group and reward those players who have lost their limit earlier than other players, thus providing an incentive to gamble at a higher rate). In another example, it may be useful for staff of the gaming location to monitor communications or other status of the player. For instance, the staff may want to identify and alert on customer service issues in near real-time.

The usefulness of such monitoring and sharing of information can be further enhanced using the player's geolocation. For instance, offers by advertisers can be made more effective by providing offers that are physically near the player, or otherwise offers that are more convenient for the player to take advantage. As in the prior example, a player who had just lost their limit earlier than other players in his/her group might be provided a coupon for a sandwich at a restaurant across the walkway from the player's present location. In another example, alerts regarding customer service issues could report not only the specific issue but also the player's physical location.

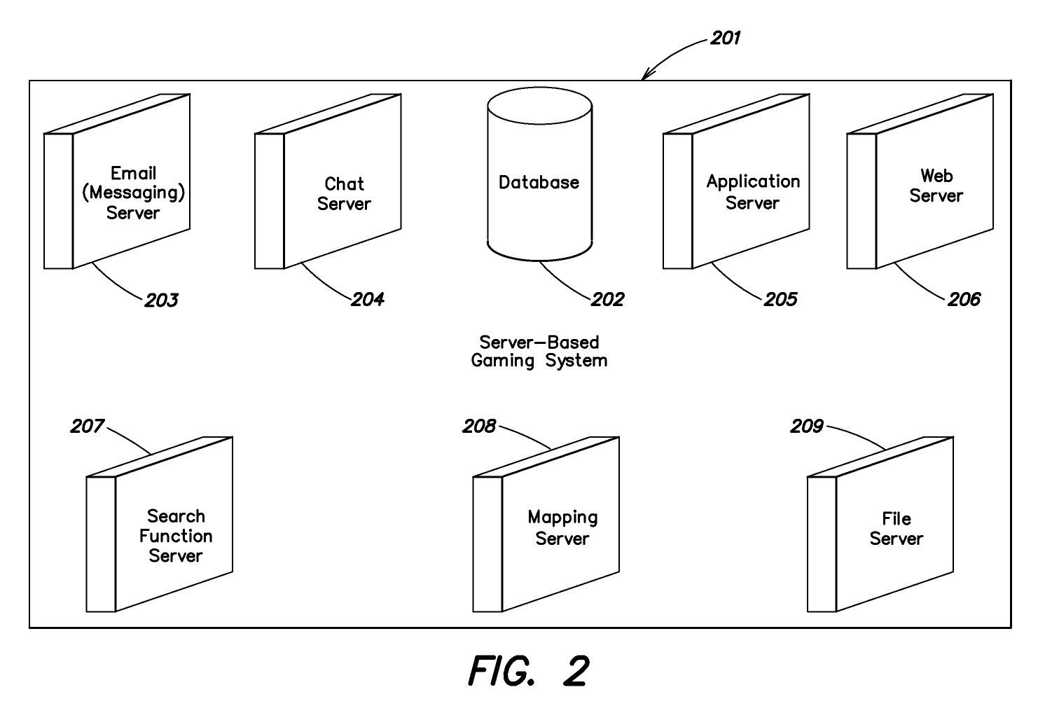

According to one aspect of the present invention, the server based gaming system generally includes one or more server-based systems (e.g., as discussed below with respect to FIG. 2) and a number of terminals through which players can interact to play wagering games. Such games may include, for instance, video poker, slots, or other types of games of chance, and some games involving various levels of skill. Terminals may include displays through which games and other information are displayed to the player. The terminal may also include any number of input devices, such as a card reader (e.g., configured to read frequent player program cards), payment system that accepts wagers (e.g., in either physical or electronic form). The terminals may also be touch-based terminals that receive inputs from players by touching the display. Other inputs may be provided, such as a mouse, trackball, or other point devices, keyboards or other input device type.

Further, it should be appreciated that the server-based gaming system may also include one or more player tracking systems (e.g., a system associated with a frequent player tracking system), or may be implemented within such a frequent player tracking system. The server-based gaming system may include other types of systems for the purposes of permitting exchange of player information using social networking functions for monitoring, communication between players/users, or any other function.

According to one aspect, social networking features may be provided to players at terminals of a server-based gaming system (e.g., terminal 102 of server-based gaming system 101). For instance, when the player plays a game at a server-based gaming terminal, the player is presented in the display of the terminal, one or more indications related to a social networking feature. Such indications may be displayed in addition to game information while the player is playing a game. Alternatively, when a game is not active, there may be a host of social networking functions available to the player through the terminal interface. Typically, these interfaces include one or more displays (including additional displays such as LCDs) that perform various functions relating to the games and other related functions. It is appreciated that some of these terminal types are being provided with more capable interfaces, and according to one implementation, social network features may be provided on such additional terminals.

In some implementations, players are permitted to play games using wireless devices while the players are on the gaming location property. Social networking features may also be implemented in these types of devices as well. Such devices may also provide some additional features, such as determining the geolocation of the player within the gambling location, and communication features that are native to the wireless devices. It should be appreciated that other types of devices may be used to implement various aspects described herein.

There may be a number of different features if a social networking system. They may include some or all of the following:
Provide information related to the player to other players For example, the player's location information, how well the player is gaming, information specific to the player may be retrieved and used to identify the player, and other information related to the player may be identified and shared with other players.
Provide access to historical information, and the ability to share that information between players. For instance, the social networking system may provide tools that permit players to share their gaming experience with other players. For example, a player may be permitted to show another player a replay of their play at a table game such as poker. Such information may be shared, for example, in a blog, a message, chat session or other social networking tool. To this end, a server-based gaming system may store historical information about the play of the player that can be replayed at a later time.
Provide compilation information using information provided by multiple players. For instance, polling results that are defined by multiple responses, gaming results for different groups of people, etc. can be compiled by the social networking system and presented to players.
Provide vehicles for communication among players to provide a better gaming environment. For example, having blog, chat, and other collaborative tools at the gaming location may permit players to interact with other players in new and interesting ways, providing for a better gaming experience. Such tools may provide functions not previously available, such as the creation of secondary gaming markets between players at the gaming location, permitting players to chat in different groups, communicate in groups (e.g., groups of friends, travel groups, junkets, etc.) while at the gaming location.
Provide another vehicle for advertising and direct marketing to the player based on their actions in the gaming location and/or their physical location. In one example, players may be identified to advertisers based on their interactions with other players, may be marketed in real time based on their actions in the gaming location.

In particular, some of the following social networking applications may be provided that may be beneficial in the gaming environment.

### Community Wiki

A wiki feature may be provided that allows community members (players) to create, collaborate, and share knowledge simply by creating a set of “living documents” to which each community member may contribute. For instance, a community member may be permitted to create their own weblog where other permitted members (e.g., a group of friends or other permitted community members) may share information with the community member and the group as a whole. Player's may be permitted to share their experiences in the gaming location among the group while they are participating in activities on the gaming floor. Some information posted in the online community may be generated by the server-based gaming or other type of gaming system, such as player status, location, how much the player has won or lost, among other information.

Wiki information may be stored by the server-based gaming system in storage and may be made available to users of the system for various reasons at a later time. Users may be permitted to view the activities and posting of others at a later time, allowing them to participate in the gaming experience even though they may not have been present at the gaming location. Administrators may use such information to determine if particular users should be restricted, or to performing other functions such as improving the communication systems and tools that help players to communicate.

### Mapping Application

A mapping feature may be provided that permits players to view a representation of the gaming location. The map may be adapted to show where players are located, for example, in a casino. Such location information may be determined, for example, when a player performs an action at one or more gaming locations. For instance, a player may swipe his/her frequent player membership card at a terminal, indentifying the player as being at that particular location. Players may also be identified using locating devices, such as a GPS provided in a cell phone, a wireless gaming device, or other facility for locating a device (e.g., RFID tags and associated access points installed within the gaming location).

Because gaming locations such as casinos may be confusing places to be, it may not be clear where certain locations are, exits, where a person's friends are, etc. Further, players unfamiliar with the location may have difficulty in locating games, attractions, and other services. According to one embodiment, a gaming terminal (such as, for example, a server-based gaming terminal) may be used to display a floor plan or other representation of the casino or other gaming location. The terminal may be adapted to display the location of the player as discussed above, as well as the locations of other players of interest.

The terminal's mapping function may be interactive, such that a player may enter search criteria and display the result of the search on the map. For example, a player may select a group of friends that the player wishes to display on the map. The display may show, for example, the location of each player as well as the status of their play. A function may be provided that tracks players of interest at any point when that particular player enters the gaming location. This may be useful, for instance, when a player has multiple friends who may or may not be at the gambling location at any particular time, and it may be beneficial for the player to receive an indication of their presence.

The terminal may also permit the player to find similar players based on one or more characteristics (e.g., height, weight, age, eye color, interests, etc.) and to locate such players on the casino floor. The terminal may also permit the player to create alarms when a person has traveled beyond a specified distance from the other person, comes within a certain distance, enters/leaves the casino or other location, etc. The location-based map may also be used to encourage player behavior, such as playing certain games (e.g., by providing in-casino bonuses to play certain games (e.g., underutilized games)), directing the player to certain services that that player may be inclined to want, or other desired activity. The location-based map may also be integrated with advertisements. Advertisers may use information provided by the social network to target ads at desired players who are in close physical proximity or who are otherwise desirable.

### Moderation Scanner

A moderation scanner may be provided that enables community administrators to rapidly scan user-contributed information in their community and identify inappropriate content. Upon discovery, administrators may quickly take a set of actions (from warning the individual to canceling their access) to ensure their community stays true to its proper purpose. To this end, the administrator may be provided tools to observe interactions among users, postings to groups, etc. so that the proper actions may be taken. Such tools may automatically scan stored content for certain phrases, keywords, and patterns, and identify that particular content as being inappropriate. The content may be, for instance, inappropriate to some players, and therefore may be removed from the system to protect the system's integrity. There may be cases where communication between players is not permitted, based on, among other things, the types of games they are playing (e.g., poker) where communication with other players is not permitted (e.g., to prevent signaling or collusion). In such cases, the player may be denied the ability to communicate using different forums or in certain instances.

### Personal User Profiles

Members of a community may be provided a personalized page with which they can provide profile information, their photo, a personal description, their interests, among other information about the player. Each member may also be provided a personal portfolio where they may upload images, documents, videos, or any other type of information. Such information may be selectively shared with the community, such as on a player-by-player basis, group basis, or by any other type of parameters. To this end, controls may be provided to the user to modify and create such access.

The player may be located by other users based on the information provided in their personal page. This information may be accessed by players at the gaming location (e.g., at a terminal of a server based gaming system) or through one or more networks such as the Internet. The personal user profile may include status information relating to the player, such as, for example, current location, ranking, types of games played, etc. Such information may be generated, for example, by a server-based gaming system as discussed above. Such server-based content may be generated as needed and displayed in the personal user profile of the user, or in other types of interfaces generated by the system (e.g., a top players screen, a location map, etc.).

Further, in another example, players may have “friends” or other associations with other community members that are stored by the system. This association information may be displayed by a player to other users on their personal page, or in other interface types generated by the system. Another function that may be performed by the system includes a referral network where players may locate other players through their associations with other players. To this end, tools may be provided that permits players to refer other players or otherwise contact players in their individual networks.

### Matchmaking

The system may be configured to suggest relevant matches for each individual via the Internet or a server based gaming network. For example, players could search for people interactively, through a casino map, or by one or more specific attributes (e.g., keywords or by selection of different attribute types) or other criteria. According to one implementation, a matching function may be provided that is two-way, taking into account mutual interests, relevant areas of expertise, and common profile attributes. For instance, players may locate each other based on interests, their gaming ability, rating, or other player information. In another implementation, the system may be configured to also identify the player's location on the casino floor, the location of the device that the player is using to access the Internet, or other method of location.

### Community Chat

Community members (e.g., players) may connect with one another in real-time, through a chat feature. Community administrators may be provided the ability to create new chat rooms, as well as track the activity of their community chats to see which topics are most interesting to their community. Chat groups may also be created dynamically in response to certain parameters (e.g., players all located within the same room at a gaming location, all players playing in a particular game, all players of a particular rating, in a particular row of terminals, etc.). The server-based gaming system may be capable of indentifying players that should be members of certain chat rooms, and assigning the players to those rooms.

### Integrated Opinion Polls

It may be also beneficial to determine what the players think about certain issues, or to otherwise determine what they are thinking Community administrators could solicit and understand the opinions and ideas of their players by creating and delivering opinion polls. These opinion polls may be displayed, for example, to the player at the terminal or other gaming location device, and information may be received and summarized to other players in near-real time. Multiple polls could be activated at any time by community administrators, depending on what information is desired. Polls may also be targeted to particular users based on their background or any other information known about the player (e.g., income level). Other opinion polls may be triggered based on actions performed by the player within the gaming environment (e.g., the player plays a particular game in the casino, the player makes a purchase, etc.).

### Private Messaging

Players may be permitted to communicate privately and directly with other members of the community. For instance, every member in the system may be provided a private in-box where they may store private discussions with other players. Further, the player may be permitted to identify players that are “online” either at the gaming location or other location (e.g., currently active at a home-based computer connected to the Internet). There may be other users that provide goods and services within the gaming location, such as administrators or game operators, that players may contact for assistance with games or other issues, service people (e.g., concierge services, hotel personnel, waitstaff) that may permit the gaming location to perform better service for their patrons.

### Blogs

Blogs may be hosted by the server based gaming system to provide community members with a personal information sharing space, in which they may post ideas and opinions to a personal online journal. Other community members could provide comments upon each blog post, providing community members with a space to create an open dialog.

### Multimedia File Sharing

Players may be provided the ability to post content in one of a number of format types (e.g., video, music, documents, etc.) to their personal profile page or post files to any group of which they are a part. Once posted, files could be rated and commented upon by the community. There also may be provided the ability to create and share new files (e.g., pictures, video, audio) at the casino location and post or send these files to other community members.

### Customized Notifications

Members could choose to be notified by email when matching people join the system, people are within the same location, within some distance away, or by any other matching criteria. Members could also receive email or subscribe to feeds (e.g., RSS feeds) for any group discussion or any event that happens on the gaming floor, such as a jackpot passing a defined threshold, a particular jackpot hitting, a new keno game about to start, an estimated lottery jackpot hitting a certain threshold, the approach of an office lottery pool deadline, among other gaming location events.

### Integrated Keyword Search

The system could support keyword searching across content (files names and descriptions) and people (players) in the system. Through one common search, members could find some or all of the following—relevant people, groups, forum posts, documents, media files, and meetings. The system may be capable of supporting tagging of content by others, performing advanced context-based searching, meaning abstraction, or other search-related functions that facilitate searching for players and their related content.

### Presence

As people navigate through the community, the system indicates the presence of another player. Presence can include online presence, but it can also include the physical location and presence of that player. In one example, when another community member is online at that time, the system may indicate this to one or more players in the community. Further, the system may be adapted to report the location of the player is geographically near another user (e.g., located on the same gaming property, within X miles of the player, etc.). This information may make it easier for the player to interact with other players.

### Discussion Forums and Rating System

In one example implementation, the system may include a complete discussion forum system which allows users to post, reply, search, and rate messages. In addition, discussions could be subscribed to (e.g., via email, RSS, etc.). Community members may also be provided a rating and comment system that enables members to provide feedback on discussion posts and files. Such feedback may also assist players in determining or searching for relevant content.

### Groups Functionality

Administrators or users may be provided the capability to set up group functions around which people can post and/or share files, engage in discussions and set up group meetings. Such groups may be interactively defined and set up by players from players that exist in the system. Players may define and save their own groups, and may contact players of such groups to arrange a group meeting. Such group meetings may support a variety of media types such as audio, video, images, documents, or similar items. The system may permit the capture and display of audio and video information among terminals to support video conferencing.

### Integrated Calendar Management

In another implementation, members of a community may be provided a personal calendar with which they could schedule meetings with other community members. In addition, a community administrator may import a master calendar into the system to either alert their members to upcoming events or promotions, or to offer structured networking to their members. In one alternative, members may be provided tools to print their promotions, or export their calendars to Outlook (or other such calendar programs).

### Integrated Invitation Management

Community administrators may be provided an ability to send invitations to their community, for example, by uploading a file listing the intended recipients.

### User Roles Management

Administrators may be provided tools that customize each role they wish to display within the system. For instance, there may be roles for different types and levels of players, employee types of the gaming establishment, or other people that interact in the community.

### Targeted Sponsorship/Advertising Engine

Administrators may be provided tools to create ad units that are featured throughout a social networking site. These ad units may be configured to include any message (combination of image, text and link) Further, these ad units may be used to feature anything from advertiser content, sponsor messaging, cross-selling messages, or featured groups within the community. Advertising units may also be broadcast throughout the site for all users to see, or they may be displayed to only subsets of the community based upon criteria within a members' profile. They also may be displayed in response to user's actions or location within the gaming location (e.g., playing a particular game, being located in a particular area). Further, the social networking site may be coupled to an ad network where advertisers pay the gaming location to reach particular players (e.g., by rating, demographic, or other information).

### Community Email Marketing

Administrators may be provided the ability to send email communications to the community. For instance, administrators may be permitted to communicate with players regarding events within the gaming location, current promotions, or other incentives that encourage players to remain in the gaming location (e.g., provide bonuses such as non-cashable credits, or entries into sweepstakes) or to achieve certain behaviors (e.g., play under-utilized games).

### Lottery Pools

Users may be provided the capability to create groups to pool and manage lottery or other gaming plays. For example, users may create a group to play a weekly lottery drawing, in which all members of the group contribute to the purchase of lottery tickets and any winnings are shared among the group. The system could help manage notifications of upcoming estimated jackpots, notify members' contribution deadlines, display lists of members and their contributions, calculate the estimated winnings for each group member, among other related functions and notifications. In jurisdictions where it is legal, the application could even collect the money via an online payment mechanism and/or could automatically purchase the lottery plays prior to the drawing.

### Problem Gambler Assistance

The system could provide a tool to assist problem gamblers. For instance, users subscribed to the tool who wish to have assistance in avoiding gambling could have friends, relatives, group members, or others notified when they are in or near a gambling establishment. Users could themselves receive notifications that reminding them of their commitments or desires to avoid gambling. In another example, the system could take some other preventative action. Alternatively, the tool could be set to monitor the total amount wagered by a player and to send alerts, notifications or take some other action when the player approaches or exceeds some pre-set limit For example, the system could send a notification to a server based gaming system that would then prevent the player from continuing to play.

### Example System

FIG. 1 shows an example system 100 in which various aspects of the present invention may be implemented. As shown, system 100 includes a private network which includes systems, networks, and other elements located at gaming location 106. According to one embodiment, social networking functions are performed by a server-based gaming system such as system 101. System 101 generally includes one or more terminals (e.g., terminal 102), upon which one or more games are played by players. Terminal 102 may include one or more displays 103 that display to the player information relating to the gaming location and/or games that are played by the player at the terminal.

Terminal 102 may also include one or more input devices 104 that permit the player to provide input to the gaming terminal. For instance, the terminal may include a mouse, track ball, or other pointing device used to select and activate social networking functions. Further, the terminal may include a keyboard, number pad, or other method of inputting information at the terminal. Further, the terminal may include a card reader, bar code reader, or other type of input device that reads frequent player cards or other identification provided by the player. According to one embodiment, social networking functions process information provided by a player at a terminal, and use such information to process, generate, or display other information to other players at other terminals of the server-based gaming system 101.

The server-based gaming system 101 may also be adapted to communicate with one or more portable terminals or gaming devices 105 for the purpose of playing games within gaming location 106.

According to one embodiment, server-based gaming system 101 may be adapted to display to the player (e.g., in one or more displays 103), one or more social networking functions that may be activated and used by the player at the terminal or other gaming device at the gaming location 106. Such social networking functions may also communicate and use information provided by one or more external systems such as a gaming establishment management system 107 (e.g., a casino management system (CMS)), a frequent player tracking system 108, payment system 109, and one or more gaming machines or systems 110. As discussed above, a great deal of information may be captured and stored about the player in a gaming establishment management system 107. Such information may be used for creating a player's personal user profile which can be stored and displayed to other players. The gaming establishment management system 107 may also store and provide other information about the player such as player rating, visit frequency, or other behavioral data relating to the player.

Also as discussed, the server-based gaming system may be integrated with a frequent player tracking system 108 which tracks the performance of the player in one or more gaming locations and awards points to the player for continued patronage. As discussed, such systems may provide performance information, point totals, or other information relating to the player that may be used in association with one or more social networking functions.

Server-based gaming system 101 may integrate with one or more other systems including payment systems (e.g., system 109), social networking sites (e.g., element 114), ad networks (e.g., element 115), or other systems either located at the gaming location 106 or anywhere throughout the public network.

The server-based gaming system 101 may also communicate player performance information with one or more stand-alone gaming machines 110 which may themselves store information about the player and his/her performance. Further, social networking functions may be integrated within such stand-alone gaming machines or in associated displays (e.g., LCD displays coupled to a gaming machine).

Also as discussed social networking functions may be used within the public network by users (e.g., user 111) operating one or more end systems such as PCs (e.g., system 116) and/or other devices that are coupled to communication network 113 (e.g., portable communication device 112 such as a PDA, cell phone or other device). Such social networking functions may be provided to such users and/or use information provided by users of the public network.

Server-based gaming system 101 may include one or more servers that perform various functions as shown by way of example in FIG. 2. Typically, a server-based gaming system includes one or more game programs that are adapted to conduct and display games that can be played by players at one or more terminals. According to one embodiment, it is appreciated that a server-based gaming system 201 that may be provided that is capable of conducting one or more social networking functions within a gaming location. To this end, server-based gaming system 201 may include one or more server systems that perform such functions. For instance, system 201 may include an email/messaging server 203 that is adapted to perform messaging functions such as email between players located in the gaming location. For instance, as discussed above, players may be provided the ability to directly communicate with each other using email while located at the gaming location. Further, system 201 may include a chat server 204 that permits players to send messages in real time to each other in a chat room format. Chat rooms may include conventional chat functionality such as that provided by a number of commercially-available chat tools such as AIM, Yahoo Messenger, and similar tools, or may include enhanced features such as video chat that permits players to view video of other players. As discussed above, players may be provided controls to create one or more chat rooms in which players may converse and/or see one another.

System 201 may include one or more application servers 205 which may provide, for example, game programs that, when executed, present a game that can be played by a player on a terminal. Application server 205 may provide other functions that may be associated with one or more of the social networking functions discussed above. Also, system 201 may be web-based and therefore may include one or more web servers 206 that handle presentation-layer functions and communicate with one or more web-based terminals operated by players.

Further, system 201 may include a server 207 that performs search functions associated with players, content, or other casino location information. As discussed, search function may be provided that allows players to locate other players based on criteria provided by the player. Also, as discussed, a match making function may be provided that performs a match between players based on information provided by both players.

A mapping server 208 may be provided that determines player location as discussed above and presents such information to other players at the gaming location. Mapping server 208 may store maps associated with the gaming location along with player location information that may be provided by terminals or other systems within the gaming location. For instance, when a player sits at a gaming terminal, that location is communicated to the mapping server 208 which is configured to present that information on a map to other players that may be interested in that player's location.

System 201 may also include a file server 209 which may be capable of storing a variety of information provided by players, such as, files provided by players that may be displayed on a personal user profile, images, documents, videos, or other type of information that may be shared among players in a community. File server 209 may also be adapted to store log information, wiki documents or any other information. System 201 may also include one or more databases 202 which can be used to locate and/or store information associated with the server-based gaming system 201.

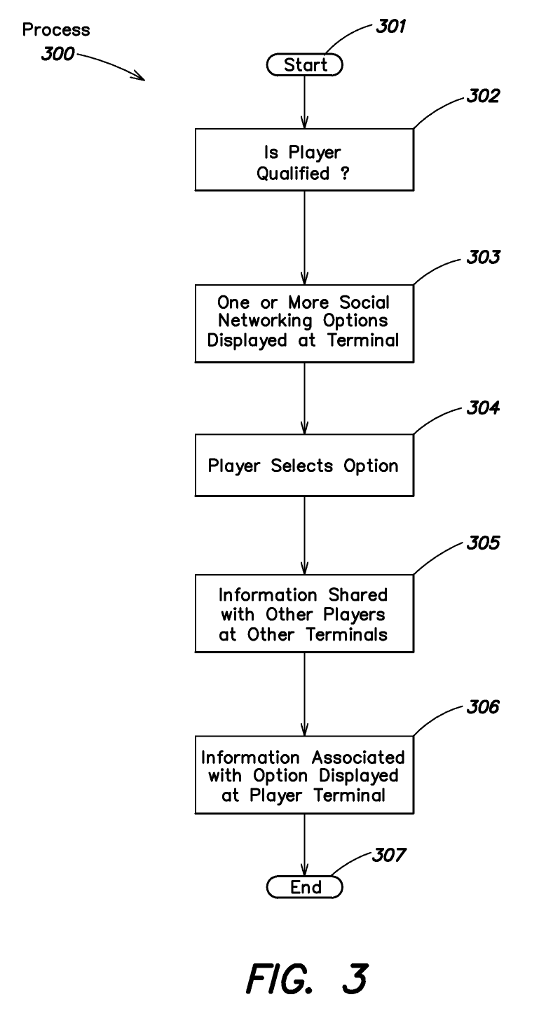

FIG. 3 shows an example process 300 that may be used to implement social networking features by a server-based gaming system (e.g., system 101 of FIG. 1, system 201 of FIG. 2). At block 301, process 300 begins. At block 302, it is determined whether a player is qualified. Qualification may be performed based on a number of criteria (e.g., level of play, rating, personal information, etc.), and may be used to determine whether a person is provided access to one or more services. In one embodiment, a player may be qualified by identification of himself/herself to the system. This may occur, for example, by requiring the player to swipe his/her frequent player card at the gaming terminal, entering in identification information (e.g., username/password, frequent player id, etc.).

In another embodiment, the player may be required to achieve a certain status prior to using certain social networking functions. For instance, the player may be required to gamble at a certain level (e.g., amount of money spent, achieve a certain player rating, etc.) in order to maintain their access to social networking services. Such status may be achieved individually, or as a group. If the group or individual does not meet the required status, they may be prohibited from using one or more social networking functions.

In yet another embodiment, a scaled social network may be provided wherein players, based on one or more factors such as the player's worth to the gaming establishment or to the social network, receive more or less service. For example, better players or social networkers get access to more and better functionality. Further, in another embodiment, players may be “scored” by a system (e.g., a server-based gaming system, ecosystem, or other system or combination of systems) based on their social networking activities. Responsive to determining a score for the player (or multiple scores, depending on what characteristic of the player's behavior is measured), that player may be provided additional social networking capability, offers from one or more providers (e.g., a casino), presented an advertisement, or be engaged by the system in a more strategic way. According to one embodiment, such social networking functions may be integrated into one or more systems such as those described in U.S. patent application Ser. No. 12/345,289, entitled “SYSTEM AND METHOD FOR COLLECTING AND USING PLAYER INFORMATION” filed Dec. 29, 2008 which is herein incorporated by reference in its entirety, which described various ecosystem components, scoring systems, and their interactions with players.

According to one embodiment, the player may be provided one or more options for performing various social networking functions. As discussed above, such functions may include any one of a number of functions including, but not limited to, chat, wild, messaging/email, blogging, conferencing, locator, searching or any other type of function that uses information collected from multiple players within the gaming location or outside of the gaming location (e.g., information collected offline or from an outside location). In one example, the system displays these social networking options to a player at a game-playing terminal (e.g., at block 303). This display may be the same or a different display than that which is used to play the game. In one embodiment, these social networking functions are presented on a secondary display associated with a gaming terminal. It is appreciated that secondary displays such as LCD displays are provided at some gaming terminals/machines. As these displays are becoming more capable, it may be beneficial to provide more advanced features that permit players to communicate in a multiplayer setting. Examples of a multiplayer system in which various embodiment may be used is described in U.S. Provisional Application Ser. No. 61/056,668 entitled “MULTIPLAYER GAMING INCENTIVE” by Mark Herrmann, filed May 28, 2008, and U.S. patent application Ser. No. 12/473,531, filed May 28, 2009, each of which applications are incorporated herein by their entirety.

At block 304, a player selects an option within the display. For instance, the user may activate a control (e.g., by selecting an icon using a pointing device or by touching an area of a touchscreen) to enable the social networking function. Thereafter, the game terminal or other system may execute a social networking function that is displayed to the player in the display. The player then is permitted to view information submitted by others within the social network, and is provided the ability to post their own information. Further, the player may be permitted to locate players within the gaming location (e.g., at a particular gaming table, at a slot machine, within a room of the gaming facility, etc.) through the display. At block 305, information provided by the player is shared with one or more other players (or administrators) at other terminals within the gaming location. This information may also be displayed by other systems and displays located outside of the gaming location (e.g., on a display of a computer system coupled to the server-based gaming system through the Internet). Other submissions and displays of information are possible. Also, information submitted by the player may be displayed at the player's own terminal at block 306. At block 307, process 300 ends, although it should be appreciated that the player may continue to activate and use the same or different social networking tools during the time the player is at the terminal.

In another embodiment discussed above, players are permitted to make wagers with each other through the social network. For instance, players may bet against each other on one or more future events that may or may not occur on the gaming floor. According to one embodiment, players may determine events upon they wish to wager, and these offered wagers may be accepted through any one of a number of social networking tools (e.g., chat, blog posting, etc.). The house may facilitate player-to-player bets and may collect a certain fee (e.g., the “vigorish” collected from the winner, loser, or both) to execute the booking. It is appreciated that a secondary betting market may be created between players, which may further their interest in remaining at the gaming location, and may provide additional interest over the actual games being offered. The system may also permit players to play each other in games of skill or skill and chance, thereby providing additional entertainment value. For instance, players may be able to set up multiplayer games between other players, and this the social network in itself may provide additional gaming options to the player.

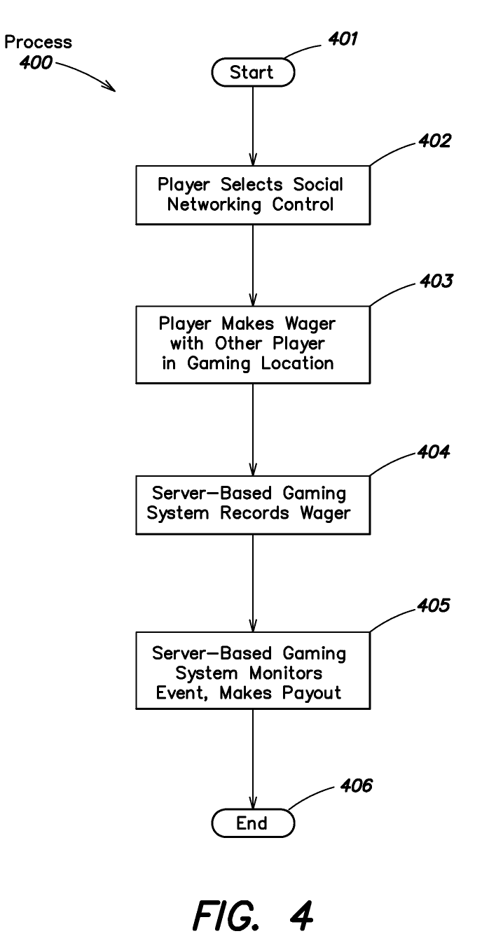

FIG. 4 shows one example process 400 for event betting according to one embodiment. At block 401, process 400 begins. At block 402, a player selects a social networking control (e.g., chat, blogging, or other function). The player may be permitted to view offers from other players that can be accepted or may submit wager offers that can be accepted. At block 403, the player makes a wager with another player at the gaming location. The gaming location operator may adjust the odds or payout depending on the amount charged for arranging the bet. At block 404, a system such as a server-based gaming system records the wager (e.g., in a memory of a computer system). At block 405, the server-based gaming system monitors the event, verifies that the event occurs and any winner(s), and may be capable of making a payout to players. At block 406, process 400 ends although it should be appreciated that bookings for events may be taken among any number of players in a continuous manner though one or more social networking tools. Also, it should be appreciated that games may be initiated between players (e.g., an online poker game) that permits players to place wagers using one or more social networking tools within the gaming location. Such games may include games of chance, skill or combination thereof.

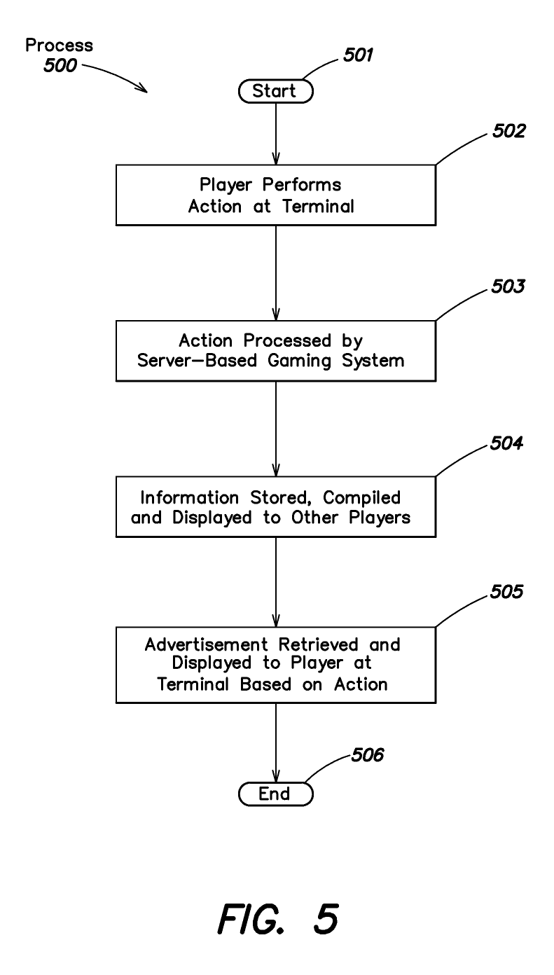

In another example process 500 as shown by way of example in FIG. 5, actions performed by players at the gambling location may be used to trigger advertisements that are displayed to players. At block 501, process 500 begins. At block 502, a player performs an action in the gaming location. For instance, the player could perform an action at the terminal with respect to a social networking function. In one example, a player may send a message to one or more players or post an entry with a blog having certain keywords. In another example, the player may sit down at a terminal and swipe their frequent player card.

At block 503, the action or other data submission may be processed by the server-based gaming system. At block 504, information associated with this action may be stored in a memory of the server-based gaming system, compiled with other information provided by the same or other users, and the information may be displayed to other players. For instance, the location of a player may be determined by a card swipe and his/her location status may be displayed to other users at other terminals. In response, an advertisement may be retrieved and displayed to the player (or a number of players) at the terminal based on the action (e.g., at block 505). For instance, an advertisement for a pay-for play bonus slot game may be displayed to a player in response to the player swiping his/her frequent player card at the terminal. In another example, several players participating in a blog about Texas-holdem may be displayed ad information based on their postings. Other opportunities for displaying ads may be created based on input provided to the social network. In one example implementation, ads may be provided by an ad network (e.g., Google Adwords) which is coupled to the server-based gaming system. These ads may be fed depending on criteria provided by the server-based gaming system, generating additional revenue for the gaming location.

### Example Interfaces

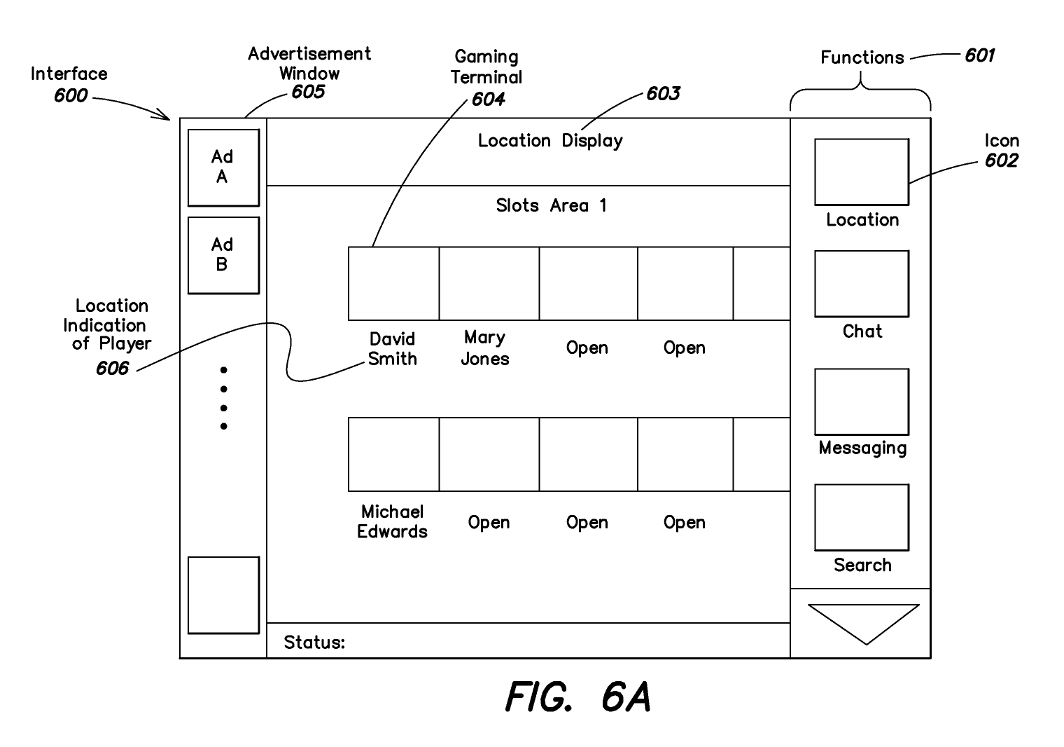

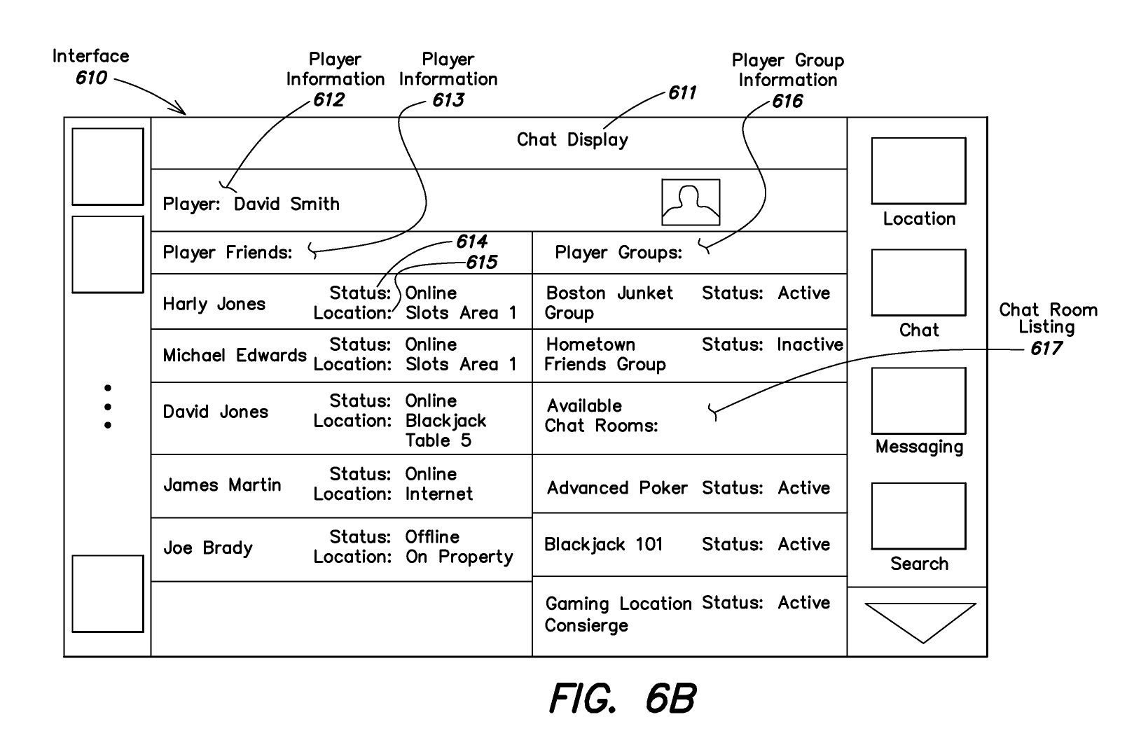

As discussed, terminals of the server-based gaming system may have the capability of performing one or more social networking functions. In particular, one or more functions may be integrated in a display used to display games, or an additional display may be provided to display social networking information and its associated interfaces. FIG. 6A shows one example interface 600 that may be displayed on a display of a terminal or one or more additional displays located in the gaming location. Interface 600 may present to the user (player) one or more representations of functions, that when selected by the player, cause the terminal to display one or more social networking functions. For instance, interface 600 may display, in one area of the interface (e.g., in area 601), representations of a number of social networking functions such as a location function, chat function, messaging function, search function or any other function. When selected by the player, the terminal displays the executed function which may have one or more associated displays that are shown to the player. The player then provides input using one or more input methods (e.g., keyboard, trackball, touch screen, etc.) to provide inputs to the social networking function.

In one example shown in FIG. 6A, a location icon (item 602) may be selected by a user using a touch screen, and in response, a location display window 603 is displayed to the player. In one embodiment, a search function may be provided that permits the player to enter into the terminal a user that the player wishes to locate, and when a search function is selected, the location of the player is displayed on a map of the gambling location. For instance, when locating user “David Smith,” an indication 606 of the player David Smith located at a gaming terminal 604 within the gaming location. Other users may be displayed, along with any other information for that particular player. For instance, in one embodiment, a player's personal profile may be displayed responsive to the player selecting a representation of the player, activating a link, executing a menu choice, or other method.

Further, interface 600 may have other functional areas such as a status window, information windows that display player information, or other indications about the player (e.g., the player has just won more than a threshold amount). Other interfaces may be presented according to the function they perform. For example, a chat window associated with a chat function may display chat entries arranged in the order they were posted, along with an entry line indicating the current entry. It should be appreciated that social networking applications and their interfaces may be similar to those provided to others that function in general-purpose networks (e.g., AOL IM for chat functions, blog platform software for developing blogs, etc.). Alternatively, custom interfaces may be created having features tailored for the gaming location environment.

One example social networking application program having features tailored for the gaming location is shown by way of example in FIG. 6B which shows an interface 610 that permits a player to perform chat functions. Interface 610 may include control and advertisement areas similar to those discussed above with reference to FIG. 6A. Further, when a player activates a control associated with a chat function, a chat display 611 may be shown to the player. Display 611 may include information about the player (e.g., the player identifier, name of the player, picture, rating information, etc.). This information may be selectable by the player and shared with other players. Some of the information (e.g., player rating, location, status information, etc.) may be automatically generated by the system (e.g., a server-based gaming system) and displayed to other players.

Interface 610 may include a number of different areas to display information. For instance, interface 610 may include an area 613 in which other players of interest may be tracked and displayed. For instance, the player (in the example, player “David Smith”) may specify other players to be listed on his/her list of players to be tracked (e.g., a “Friends” list or any number of other lists). Status information (e.g., status information 614) may be displayed in the display that indicates, for example, the player's status within the gaming location (e.g., online, offline, gaming, inactive, etc.). Other status information such as the location of another player (e.g., location information 615) may also be displayed to the player in display 611. For instance, the location information displayed may indicate where in the gaming location the player is located. The interface may also permit the player to select a player and then display the location of that player on a map, similar to the display shown in FIG. 6A. Representations of the players, when selected in the interface 610, may cause a chat window to be displayed (not shown) which permits the player to chat with the selected player. This selection may cause a display located at a terminal of the selected player to navigate to a chat function, or otherwise provide an alarm or indication that indicates that the player wishes to chat. Other features may be launched from this view, such as messaging the player, contacting the player to trade, buy or otherwise transfer cash, credits, and/or points between players, send a file, or initiate any other social networking function.

Further, display 611 may also include player group information (e.g., player group information 616) for groups created by players or administrators. For instance, the player may set up one or more groups (e.g., a group of friends, organization, or other parameter) that can communicate in a group chat setting. Interface 610 may also include an area where available chat rooms are listed (e.g., list 617), and may be selected by a player. When selected, a chat window may displayed that shows chat entries posted by other users, as well as an area that the player can post submissions.

Another interface may be provided that permits players to replay gaming experiences themselves or to share their experiences using one or more social networking tools. For instance, the player, after leaving the casino, may wish to see his/her previous play. To this end, the player may be permitted to access a replay (e.g., in a display of a computer system) that shows his/her play. For example, a computer display of players playing cards at a poker table may be displayed to the player, and the player may be presented controls that permit the play to be shown. Such information may be shared with others using social networking tools, or may be accessed by the player for training purposes.

Other interfaces may be provided, such as ones that permit players to transfer credits from one player to another, trade frequent player points, trade complimentary offers, or otherwise transfer items of value between players. Other interfaces may show player and/or game status that can be displayed in a social network including win proximity displays that show how close a particular machine or player is to achieving a win, progressive jackpot status displays, interfaces that display bet exchanges and their data, interfaces to select and display the status of other games occurring in the social network.

### Open API and Widget Toolkit

According to one example implementation, the system may be configured to support open standards so that customers may refine, extend, and integrate their community as they see fit. The system may also integrate with other systems including, but not limited to, casino management systems (CMSs) that track casino gaming activity, server-based gaming systems as discussed above, other social networking sites (e.g., to draw information from or share information with other social networking sites), frequent player tracking systems, advertising network systems (e.g., Google Adwords) or any other system, either operated by the gaming location or other entity.

There are many different types of games that can be provided for entertainment separate from the gaming location environment that may also benefit by using social networking tools. For instance, lottery tickets are sold through retailers using machines referred to as point of sale (POS) terminals to permit players to play such games. These tickets are generally printed at the POS terminal, and are usually issued for some lottery drawing to be performed at a later time. Examples of these types of lottery games of chance include traditional state lottery drawings and multi-state lottery drawings (e.g., PowerBall). Another well-known drawing-based game includes the game of Keno. Further, there are many online games that can be played using a computer system coupled to a communication network (e.g., the Internet). These games may include traditional games of chance, games of skill, and casino-type games, among others, some of which may involve online gaming. Also, other online games such as bonus games provided at the gaming location may be integrated with social networking functions. A players' participation in one of these online games may be communicated to a social networking function, and such information may be integrated and/or shared with other players.

As discussed, the server-based gaming system and its associated social networking features may be integrated with frequent-player tracking systems (e.g., frequent player tracking system 108) or any other type of incentive program and its associates systems and data. Numerous organizations and companies have incentive programs for customers that track frequent customers. For example, airlines have frequent flyer programs that allow a member passenger to take free trips or provide other perks after the member has taken a minimum number of flights or has flown a minimum number of miles. Numerous other types of establishments, including hotel chains, chain stores, and movie rental companies, have similar programs used to incentivize a customer.

Casinos also often have similar frequent player programs that provide incentives for continued customer patronage. For instance, the Foxwoods Casino (Mashantucket, CT) offers a program referred to as Wampum Rewards. A player participating in the program receives a card which the player uses whenever he/she comes to the casino. In one example implementation, the player swipes the card at special kiosks located within the casino which permit that player to have a chance to win prizes. A Wampum Rewards member may also swipe his or her card whenever betting or spending money within the casino and in the associated hotel, resort, or shops. As the player bets or spends more money, the player becomes eligible for free or reduced cost perks. Other examples of frequent player programs used in the casino environment include the well-known Harrah's Total Rewards, Wynn Casino's Red Card, and Trump Casinos' Trump Card programs. According to one embodiment, social networking functions may use information provided by such a frequent player tracking system to process, use, or display information to players at other terminals.

As with frequent flyer programs and other types of incentive programs, typical goals of the casino frequent player program include increasing player loyalty, providing incentives to a player to visit the associated casinos as often as possible, and encouraging the player to spend as much money in the associated establishments as possible. To further improve the effectiveness of player loyalty programs, there is a present and recurring need for new methods to provide incentives to frequent player program members. According to one embodiment, frequent player tracking programs may be integrated with social network functions to permit players to share frequent player program information, as well as encouraging frequent player program use. Further, the player's actions within the gaming location may also be tracked based on their use of frequent player identifiers within the location (e.g., by swiping his/her card at locations within the gaming location).

Also, as discussed, players may be qualified prior to the use of social networking functions. Qualification may be or may not be independent of game play. For example, player status may be used to determined qualification. A player who plays frequently may achieve a preferred status with respect to the online gaming environment. In one example, achievement of a preferred status may be used as qualification for an invitation, and upon achieving preferred status, the player may be permitted to participate in a social network made up of other players. One should appreciate that achieving a preferred status may be accomplished in any number of ways. In one example, a preferred status may be earned by completing events in association with the online player's account and in another, by earning points from game play. Referring friends earns preferred status in another example. Other player status qualifications include being a new player, first time player, or a player who plays infrequently, as some examples.

A player, having inserted a frequent player card into a gaming machine may be tracked by a gaming establishment management system (e.g., a casino management system), frequent player management system, or within the memory of one or more gaming machines. In one example, a slot management system provides tracking functions. Tracking may include statistics on game play, for example, coin in per hour, number of wagers, amount of wager, credits wagered over time, average time of play, and may include other statistics not dependent on game play average number of visits, average length of visit, and present length of visit as examples.

Qualification to use social networking functions, or to communicate with particular users may be earned with respect to the tracked statistics. In one example, a video poker player has her frequent player card inserted in a video poker gaming machine. During play, the players' statistics are reported to a casino management system, which may include a slot management system, or a frequent player tracking system. Players' statistics may also be reported to a separate or integrated qualification system. In one example, a qualification system has predefined qualifications for issuing an invitation to a player. In one example, the qualification comprises a certain number of credits wagered per hour. In one embodiment, in response to a player meeting the qualification, the qualification system communicates with the player that access to particular social networking functions are permitted.

Other qualifications related to game play are used in various embodiments. Different examples include, time of play, time of play per session (over day or month or year(s)), average time of play, coin in per time period, average coin in for a player over a time period, money lost, money won, time of play, length of play, average statistics, credits wagered, and average wager, etc. Qualification may also be related to player status or player activity. Some examples include trips to a gaming location, number of days at a gaming location, time spent at a gaming location, average duration of a trip, average number of trips to a gaming location, etc.

One should appreciate that any number of qualifications may be used that are associated with gaming activity, gaming activity, player status or any combination thereof. In response to qualification being determined, the player may be permitted to use various social networking functions. In one example, the player may only need to be identified with the system, such that the player's activity may be tracked and recorded.

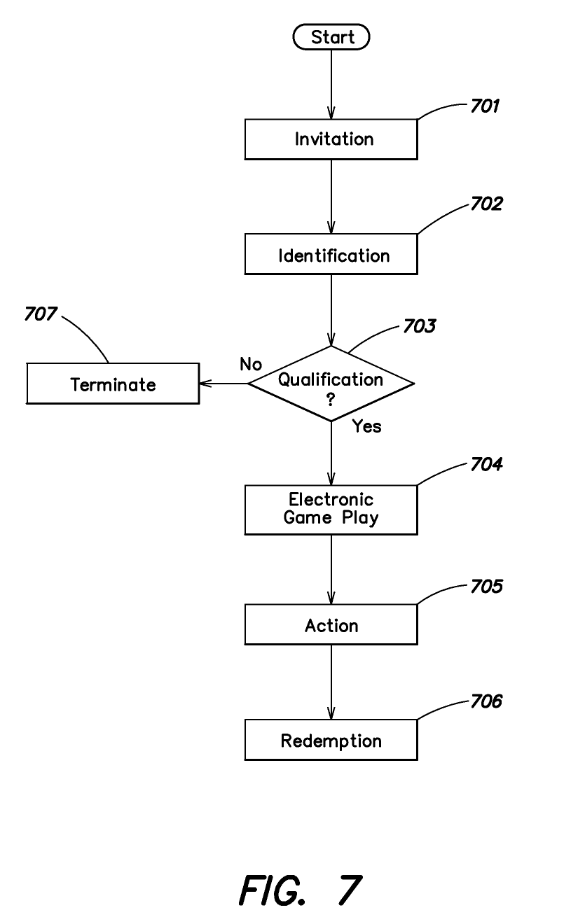

One implementation includes using information provided by and providing social networking functions within other types of systems. One embodiment of the present invention is implemented in a bonus play system that performs acts of invitation, identification, qualification, play and action, as represented in FIG. 7. Step 701 is invitation, wherein a person is invited to participate in a bonus play game to encourage that person (player) to perform a particular behavior (e.g., an action at a gaming location). Social networking functions may use information provided by the bonus game system (e.g., information related to qualification of the player) or may be embedded in the bonus play system itself.

Act 702 includes an identification, where the person's identity is ascertained. Act 703 includes a test of qualification, wherein the person is measured against predefined criteria to determine if they are eligible to participate (e.g., to play an electronic game at act 704). If the person is unqualified, he/she is excluded from play at act 707.

Qualified persons are presented an opportunity to play all or portions of an electronic game, which includes a plurality of outcomes, at least one of which is a winning outcome. When electronic game play concludes (e.g., at act 704), depending on outcome, the person may be offered an opportunity to take an action at act 705. Awards earned by taking the action are then redeemed at act 706 (e.g., for prizes associated with the invitation). In one embodiment of the invention, the acts of action 705 and redemption 706 may be combined into a single act.

While FIG. 7 shows at least one example of the present invention which represents the acts of invitation, identification, qualification, play, action and redemption as occurring in a specific order, it should be appreciated that the order of these acts may be altered and remain within the scope and spirit of the present invention.

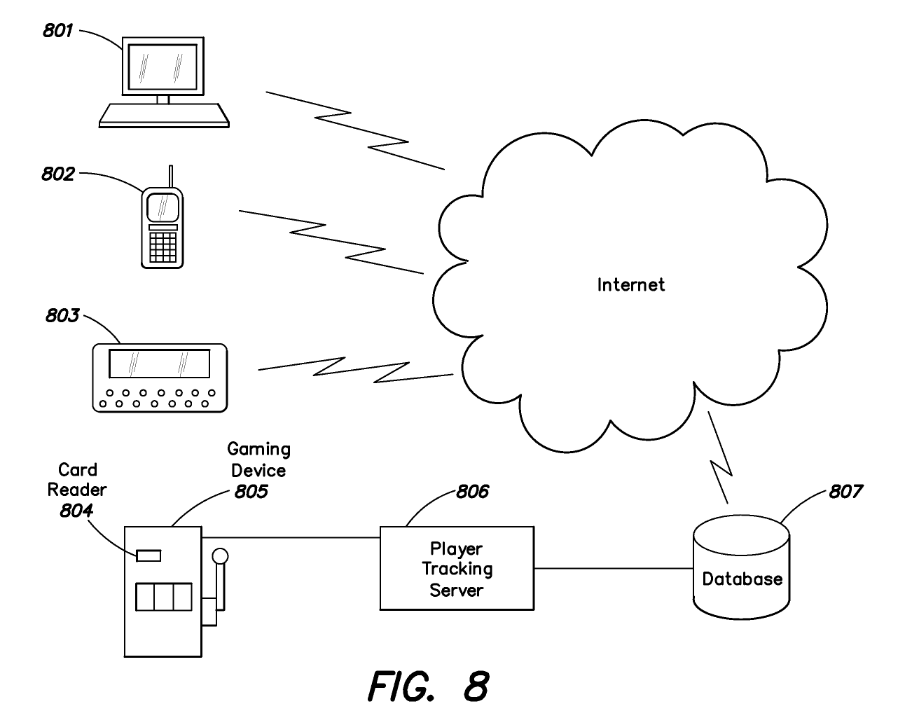

FIG. 8 shows an environment suitable for implementing various aspects of the present invention. As illustrated in FIG. 8, an invited person may then play electronic games at their home computer 801, Internet enabled cell phone 802 or other Internet device 803. When the invited person first arrives at a website, she identifies herself by entering her player ID number, which is also assigned to the player tracking account at the gambling location. This identifier is used to index the player database 807, where the person's electronic game parameters are stored in accordance to the category to which that person is qualified.

The invited person may also have access to social networking functions that connect players in the gaming location with players/users located outside of the gaming location. Such access to social networking features may be provided, for example, on a website of a gaming system location, or may be presented as part of an online game (e.g., an Internet-based game associated with the gaming location). Play of such an online game and its associated award may provide additional incentive for the home-based player to return to the gaming location.

To play such an online game, a small application program may be downloaded to the person's computer, cell phone or other Internet enabled device. This application may randomly determine each electronic game's outcome according to the database parameters for that person. Award amounts from each outcome are stored in database 807 along with annotations showing that an electronic game was completed. The person continues electronic game play until she exhausts her supply of electronic games, again according to parameters stored in database 807.

To redeem the awards won, the player visits a designated gaming location and inserts her player tracking card into the card reader 804 of any connected gambling device 805. The gambling location's player tracking server 806 reads the identity code from the inserted card and requests the identified person's award record from database 807. The player tracking server then transfers the appropriate amount of non-cashable credit to the gambling device 805, which makes said noncashable credits available for play. As each non-cashable credit is wagered, it is deducted from the award balance maintained on database 807. According to one embodiment, when all non-cashable credits are exhausted, or time period parameters are exceeded, no additional non-cashable credit play is allowed.

As discussed above, various aspects of the present invention may be implemented within various environments. For example, instead of downloading an application to the person's computer, cell phone, PDA or other system, the game and/or social networking features could be entirely resident on a server-based network. Further, the game could be accessed by the player through an interface such as the interface of the well-known Internet Explorer browser program or the well-known Firefox browser program available from Mozilla.

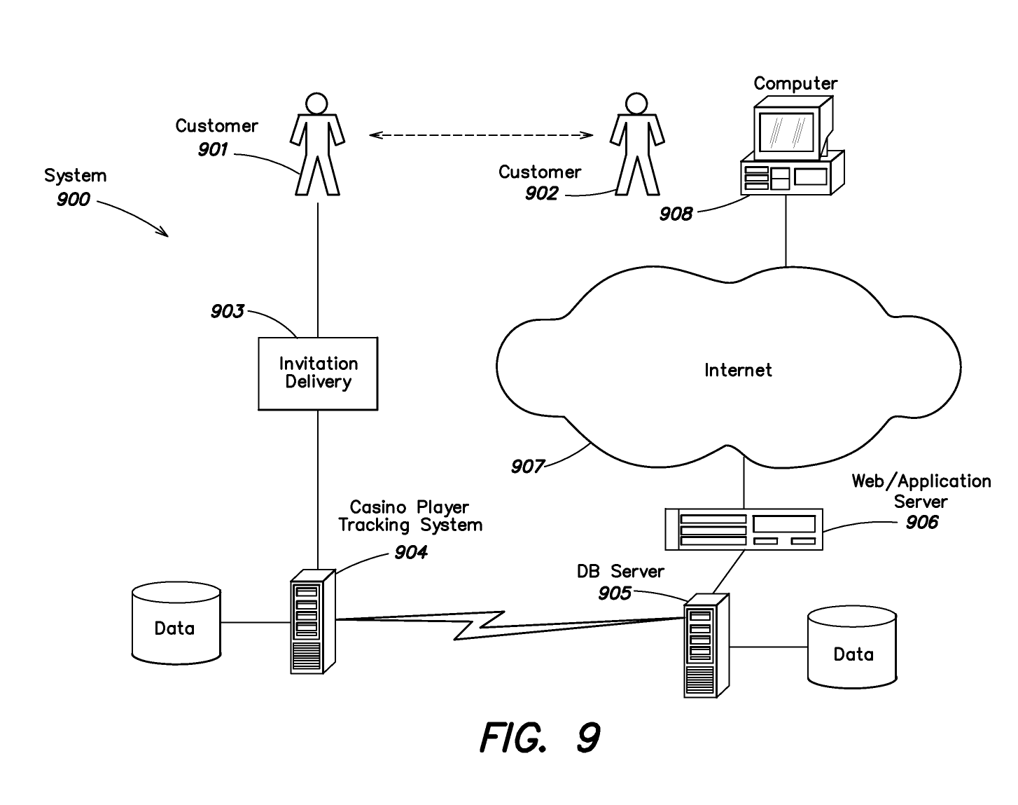

FIG. 9 shows another environment suitable for implementing various aspects of the present invention. In particular, FIG. 9 shows a distributed system 900 in which a user or customer (elements 901, 902) receives an invitation to play one or more electronic games. At block 903, the system may deliver an invitation to the player. The invitation may be delivered using any of the methods previously described herein.

According to one embodiment, the player may receive an invitation to play the electronic game, and may play the electronic game on a computer 908 (e.g., a personal computer (PC)). However, it should be appreciated that the user may access the electronic game on other types of computing systems, and the invention is not limited thereto. In addition, play of the online game may provide information to the social network, or otherwise the player may access social networking functions while playing the online game. This capability may permit the player to communicate with one or more players located at the gaming location.

As discussed, the user may play a game over a distributed network such as the Internet (element 907). As discussed above, the game may be a web-based game that implements one or more server systems, such as web/application server 906 and/or database server 905. However, it should be appreciated that other types of Internet architectures may be used.

Further, according to one embodiment, the user that is provided the invitation may be identified in a player tracking system or another casino system. For instance, the user may be identified in a casino player tracking system 904. Although player tracking systems are implemented in casinos, it should be appreciated that various aspects of the invention may be applied to player tracking systems implemented in other environments (e.g., slot parlors, racinos, amongst others).

### Implementations

Processes described above are merely illustrative embodiments of a method for conducting a game that uses social networking functions at a gaming location or online

Such illustrative embodiments are not intended to limit the scope of the present invention, as any of numerous other implementations for performing the invention. None of the claims set forth below are intended to be limited to any particular implementation of a method of providing player incentives, unless such claim includes a limitation explicitly reciting a particular implementation.

Processes and methods associated with various embodiments, acts thereof and various embodiments and variations of these methods and acts, individually or in combination, may be defined by computer-readable signals tangibly embodied on a computer-readable medium, for example, a non-volatile recording medium, an integrated circuit memory element, or a combination thereof. Such signals may define instructions, for example, as part of one or more programs, that, as a result of being executed by a computer, instruct the computer to perform one or more of the methods or acts described herein, and/or various embodiments, variations and combinations thereof. Such instructions may be written in any of a plurality of programming languages, for example, Java, Visual Basic, C, C#, or C++, Fortran, Pascal, Eiffel, Basic, COBOL, etc., or any of a variety of combinations thereof. The computer-readable medium on which such instructions are stored may reside on one or more of the components of a general-purpose computer described above, and may be distributed across one or more of such components.

The computer-readable medium may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to partially or fully automate play of the described game according to various embodiments of the invention. Further, the software design system may be located on a single computer or may be distributed among a plurality of computers attached by a communications network.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

A computer system may be a general-purpose computer system that is programmable using a high-level computer programming language. Computer system may be also implemented using specially programmed, special purpose hardware. In a computer system there may be a processor that is typically a commercially available processor such as the well-known Pentium class processor available from the Intel Corporation. Many other processors are available. Such a processor usually executes an operating system which may be, for example, the Windows 95, Windows 98, Windows NT, Windows 2000 (Windows ME), Windows XP, or Windows Visa operating systems available from the Microsoft Corporation, MAC OS System X available from Apple Computer, the Solaris Operating System available from Sun Microsystems, or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Further, on each of the one or more systems that include one or more components of system 101, each of the components may reside in one or more locations on the system. For example, different portions of the components of system 101 may reside in different areas of memory (e.g., RAM, ROM, disk, etc.) on the system. Each of such one or more systems may include, among other components, a plurality of known components such as one or more processors, a memory system, a disk storage system, one or more network interfaces, and one or more busses or other internal communication links interconnecting the various components.

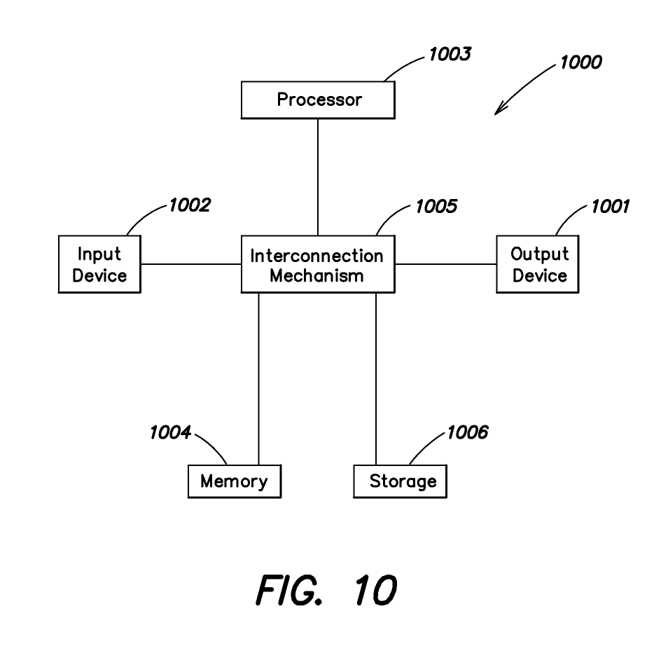

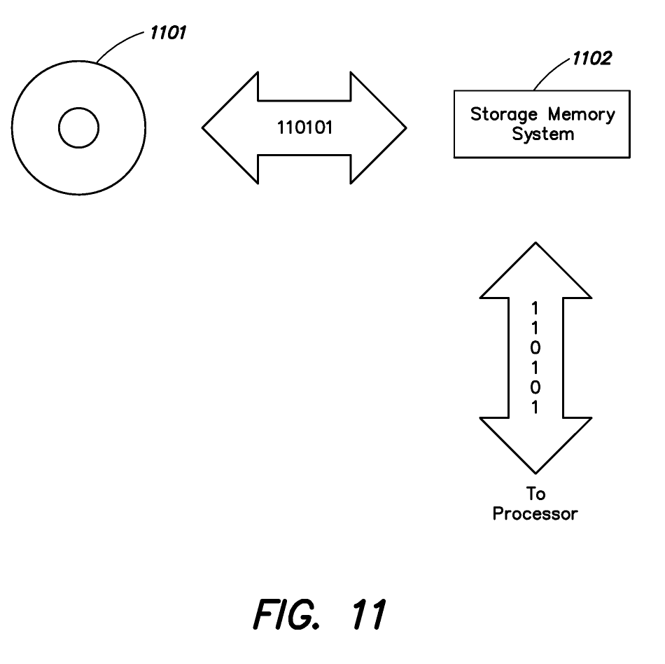

System 101 may be implemented on a computer system described below in relation to FIGS. 10 and 11.

System 101 is merely an illustrative embodiment of the server-based gaming system. Such an illustrative embodiment is not intended to limit the scope of the invention, as any of numerous other implementations of the based gaming system, for example, are possible and are intended to fall within the scope of the invention. For example, social networking functions may be implemented in a casino management system (CMS), frequent player tracking system, or other type of system used at the gaming location. None of the claims set forth below are intended to be limited to any particular implementation of the betting system unless such claim includes a limitation explicitly reciting a particular implementation.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to partially or fully automate play of the described game according to various embodiments of the invention. Further, the software design system may be located on a single computer or may be distributed among a plurality of computers attached by a communications network.

For example, various aspects of the invention may be implemented as specialized software executing in a general-purpose computer system 1000 such as that shown in FIG. 10. The computer system 1000 may include a processor 1003 connected to one or more memory devices 1004, such as a disk drive, memory, or other device for storing data. Memory 1004 is typically used for storing programs and data during operation of the computer system 1000. Components of computer system 1000 may be coupled by an interconnection mechanism 1005, which may include one or more busses (e.g., between components that are integrated within a same machine) and/or a network (e.g., between components that reside on separate discrete machines). The interconnection mechanism 1005 enables communications (e.g., data, instructions) to be exchanged between system components of system 1000. Computer system 1000 also includes one or more input devices 1002, for example, a keyboard, mouse, trackball, microphone, touch screen, and one or more output devices 1001, for example, a printing device, display screen, and/or speaker. In addition, computer system 1000 may contain one or more interfaces (not shown) that connect computer system 1000 to a communication network (in addition or as an alternative to the interconnection mechanism 1005.

The storage system 1006, shown in greater detail in FIG. 11, typically includes a computer readable and writeable nonvolatile recording medium 1101 in which signals are stored that define a program to be executed by the processor or information stored on or in the medium 1101 to be processed by the program. The medium may, for example, be a disk or flash memory. Typically, in operation, the processor causes data to be read from the nonvolatile recording medium 1101 into another memory 1102 that allows for faster access to the information by the processor than does the medium 1101. This memory 1102 is typically a volatile, random access memory such as a dynamic random access memory (DRAM) or static memory (SRAM). It may be located in storage system 1006, as shown, or in memory system 1004, not shown. The processor 1003 generally manipulates the data within the integrated circuit memory 1004, 1102 and then copies the data to the medium 1101 after processing is completed. A variety of mechanisms are known for managing data movement between the medium 1101 and the integrated circuit memory element 1004, 1102, and the invention is not limited thereto. The invention is not limited to a particular memory system 1004 or storage system 1006.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 1000 is shown by way of example as one type of computer system upon which various aspects of the invention may be practiced, it should be appreciated that aspects of the invention are not limited to being implemented on the computer system as shown in FIG. 10. Various aspects of the invention may be practiced on one or more computers having a different architecture or components that that shown in FIG. 10.

Computer system 1000 may be a general-purpose computer system that is programmable using a high-level computer programming language. Computer system 1000 may be also implemented using specially programmed, special purpose hardware. In computer system 1000, processor 1003 is typically a commercially available processor such as the well-known Pentium class processor available from the Intel Corporation. Many other processors are available. Such a processor usually executes an operating system which may be, for example, the Windows 95, Windows 98, Windows NT, Windows 2000 (Windows ME), Windows XP, or Windows Visa operating systems available from the Microsoft Corporation, MAC OS System X available from Apple Computer, the Solaris Operating System available from Sun Microsystems, or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Having now described some illustrative embodiments of the invention, it should be apparent to those skilled in the art that the foregoing is merely illustrative and not limiting, having been presented by way of example only. For instance, although many embodiments are applicable to a casino location or gaming location, various aspects may be applied to lotteries and lottery point-of-sale locations, and social networking functions may be adapted to communicate and share information among lottery patrons and lottery providers. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any means, known now or later developed, for performing the recited function.

As used herein, whether in the written description or the claims, the terms “comprising”, “including”, “containing”, “characterized by” and the like are to be understood to be open-ended, i.e., to mean including but not limited to. Only the transitional phrases “consisting of” and “consisting essentially of”, respectively, shall be closed or semi-closed transitional phrases, as set forth, with respect to claims, in the United States Patent Office Manual of Patent Examining Procedures (Eighth Edition 2nd Revision, May 2004), Section 2111.03.

Use of ordinal terms such as “first”, “second”, “ third”, “a”, “b” “c” etc., in the claims to modify or otherwise identify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A method for conducting a computer-based game in a legal gaming location, the method comprising acts of:
providing, at a terminal associated with a server-based gaming system, at least one game that may be played by a player in the legal gaming location; and
providing, at the terminal associated with the server-based gaming system, at least one social networking function that presents, to the player, information relating to a plurality of players located at the legal gaming location.

2. The method according to claim 1, further comprising, an act of indicating to the player, a location of at least one of the plurality of players at the legal gaming location.

3. The method according to claim 1, further comprising, an act of indicating to the player, a map of the gaming location, and indicating a presence of at least one of the plurality of players on the map of the gaming location.

4. The method according to claim 1, wherein the at least one social networking function comprises:
a chat function;
a wild function;
a blogging function;
a player search function;
an opinion polling function;
a messaging function; and
a file sharing function.

5. The method according to claim 1, further comprising an act of determining a location of the player based on an act performed by the player within the legal gaming location.

6. The method according to claim 5, further comprising an act of determining, by the server-based gaming system, the location of the player based on the act which is performed at a terminal of the server-based gaming system.

7. The method according to claim 1, further comprising an act of displaying, to the player at the terminal associated with the server-based gaming system, information shared among the plurality of players.

8. The method according to claim 1, further comprising an act of providing, to the player at the terminal associated with the server-based gaming system, a control that permits the player to create a group of associations with other players.

9. The method according to claim 1, further comprising an act of providing, to the player at the terminal associated with the server-based gaming system, a control that permits a player to search for other players based on a set of criteria provided by the player.

10. The method according to claim 1, further comprising an act of providing, to the player at the terminal associated with the server-based gaming system, a control that permits at least two players to locate each other based on criteria provided by both of the at least two players.

11. The method according to claim 1, further comprising an act of providing, to the player at the terminal associated with the server-based gaming system, an advertisement based on an action performed by the player responsive to the provided at least one social networking function.

12. The method according to claim 1, wherein the terminal associated with the server-based gaming system is adapted to accept a wager from the player to play a wagering game.

13. The method according to claim 1, further comprising an act of compiling information provided by players by the at least one social networking function, and presenting the compiled information to the player at the terminal associated with the server-based gaming system.

14. The method according to claim 1, further comprising an act of presenting the information to a user of a computer system coupled to the server-based gaming system through a communication network.

15. The method according to claim 14, wherein the computer system comprises a general purpose computer system.

16. The method according to claim 1, wherein the legal gaming location includes a physical gaming location comprising at least one of:
a casino;
a racino;
a dog-racing track;
a horse-racing track;
a point-of-sale location;
a riverboat;
a legal gaming site;
a lottery retailer;
an off-track betting facility;
a sports betting parlor; and
a parlor that offers amusements with prizes.

17. The method according to claim 1, further comprising an act of qualifying the player by the server-based gaming system, and providing the at least one social networking function responsive to the qualification.

18. The method according to claim 1, further comprising an act of permitting at least two players to make a wager with each other using the at least one social networking function.

19. The method according to claim 1, wherein the server-based gaming system is configured to arbitrate a wager between at least two players using the at least one social networking function.

20. The method according to claim 1, further comprising an act of displaying the information relating to a plurality of players located at the legal gaming location during play of the at least one game by the player in the legal gaming location.

21. The method according to claim 1, further comprising an act of providing, to the player at the terminal associated with the server-based gaming system, an advertisement based on an interaction between at least two players using the provided at least one social networking function.

22. The method according to claim 1, further comprising presenting, to at least one other player in another terminal associated with the server-based gaming system, a personal user profile of the player.

23. The method according to claim 22, wherein the personal user profile of the player includes content provided by the player, and wherein the method comprises displaying, to the at least one other player, the provided content.

24. The method according to claim 1, further comprising an act of permitting the player to selectively share the personal user profile with one or more other players.

25. The method according to claim 22, further comprising an act of storing, in the personal user profile of the player, one or more content items provided by the server-based gaming system.

26. The method according to claim 1, further comprising an act of providing, at a computer system located outside of the legal gaming location, access to a social networking function that permits communication with a plurality of players in the legal gaming location.

27. The method according to claim 1, further comprising an act of providing, at a computer system located outside of the legal gaming location, access to a social networking function that permits a person operating the computer system to view a status of the player located in the legal gaming location.

28. The method according to claim 1, further comprising an act of permitting the player and at least one other player to transfer items using the social networking tool.

29. The method according to claim 28, wherein the items include at least one of a group comprising credits, non-cashable credits, frequent player program points, and cash.

30. A computer-readable medium having computer-readable signals stored thereon that define instructions that, as a result of being executed by a computer, instruct the computer to perform a method for conducting a computer-based game in a legal gaming location, the method comprising acts of:
providing, at a terminal associated with a server-based gaming system, at least one game that may be played by a player in the legal gaming location; and
providing, at the terminal associated with the server-based gaming system, at least one social networking function that presents, to the player, information relating to a plurality of players located at the legal gaming location.

31. The computer readable medium according to claim 30, further comprising, an act of indicating to the player, a location of at least one of the plurality of players at the legal gaming location.

32. The computer readable medium according to claim 30, further comprising, an act of indicating to the player, a map of the gaming location, and indicating a presence of at least one of the plurality of players on the map of the gaming location.

33. The computer readable medium according to claim 30, wherein the at least one social networking function comprises:
a chat function;
a wild function;
a blogging function;
a player search function;
an opinion polling function;
a messaging function; and
a file sharing function.

34. The computer readable medium according to claim 30, further comprising an act of determining a location of the player based on an act performed by the player within the legal gaming location.

35. The computer readable medium according to claim 34, further comprising an act of determining, by the server-based gaming system, the location of the player based on the act which is performed at a terminal of the server-based gaming system.

36. The computer readable medium according to claim 30, further comprising an act of displaying, to the player at the terminal associated with the server-based gaming system, information shared among the plurality of players.

37. The computer readable medium according to claim 30, further comprising an act of providing, to the player at the terminal associated with the server-based gaming system, a control that permits the player to create a group of associations with other players.

38. The computer readable medium according to claim 30, further comprising an act of providing, to the player at the terminal associated with the server-based gaming system, a control that permits a player to search for other players based on a set of criteria provided by the player.

39. The computer readable medium according to claim 30, further comprising an act of providing, to the player at the terminal associated with the server-based gaming system, a control that permits at least two players to locate each other based on criteria provided by both of the at least two players.

40. The computer readable medium according to claim 30, further comprising an act of providing, to the player at the terminal associated with the server-based gaming system, an advertisement based on an action performed by the player responsive to the provided at least one social networking function.

41. The computer readable medium according to claim 30, wherein the terminal associated with the server-based gaming system is adapted to accept a wager from the player to play a wagering game.

42. The computer readable medium according to claim 30, further comprising an act of compiling information provided by players by the at least one social networking function, and presenting the compiled information to the player at the terminal associated with the server-based gaming system.

43. The computer readable medium according to claim 30, further comprising an act of presenting the information to a user of a computer system coupled to the server-based gaming system through a communication network.

44. The computer readable medium according to claim 43, wherein the computer system comprises a general purpose computer system.

45. The computer readable medium according to claim 30, wherein the legal gaming location includes a physical gaming location comprising at least one of:
a casino;
a racino;
a dog-racing track;
a horse-racing track;
a point-of-sale location;
a riverboat; and
a legal gaming site;
a lottery retailer;
an off-track betting facility;
a sports betting parlor; and
a parlor that offers amusements with prizes.

46. The computer readable medium according to claim 30, further comprising an act of qualifying the player by the server-based gaming system, and providing the at least one social networking function responsive to the qualification.

47. The computer readable medium according to claim 30, further comprising an act of permitting at least two players to make a wager with each other using the at least one social networking function.

48. The computer readable medium according to claim 30, wherein the server-based gaming system is configured to arbitrate a wager between at least two players using the at least one social networking function.

49. The computer readable medium according to claim 30, further comprising an act of displaying the information relating to a plurality of players located at the legal gaming location during play of the at least one game by the player in the legal gaming location.

50. The computer readable medium according to claim 30, further comprising an act of providing, to the player at the terminal associated with the server-based gaming system, an advertisement based on an interaction between at least two players using the provided at least one social networking function.

51. The computer readable medium according to claim 30, further comprising presenting, to at least one other player in another terminal associated with the server-based gaming system, a personal user profile of the player.

52. The computer readable medium according to claim 51, wherein the personal user profile of the player includes content provided by the player, and wherein the method comprises displaying, to the at least one other player, the provided content.

53. The computer readable medium according to claim 30, further comprising an act of permitting the player to selectively share the personal user profile with one or more other players.

54. The computer readable medium according to claim 51, further comprising an act of storing, in the personal user profile of the player, one or more content items provided by the server-based gaming system.

55. The computer readable medium according to claim 30, further comprising an act of providing, at a computer system located outside of the legal gaming location, access to a social networking function that permits communication with a plurality of players in the legal gaming location.

56. The computer readable medium according to claim 30, further comprising an act of providing, at a computer system located outside of the legal gaming location, access to a social networking function that permits a person operating the computer system to view a status of the player located in the legal gaming location.

57. The computer readable medium according to claim 30, further comprising an act of permitting the player and at least one other player to transfer items using the social networking tool.

58. The computer readable medium according to claim 57, wherein the items include at least one of a group comprising credits, non-cashable credits, frequent player program points, and cash.

59. A server-based game system comprising:
at least one server-based system configured to execute one or more game programs and is configured to provide at least one social networking function that presents information relating to a plurality of players located at a legal gaming location; and
a terminal configured to display at least one game that is adapted to be played by a player within the legal gaming location, the terminal being configured to display the information relating to the plurality of players.

60. The system according to claim 59, further comprising a component adapted to indicate to the player, a location of at least one of the plurality of players at the legal gaming location.

61. The system according to claim 59, further comprising a component adapted to indicate to the player, a map of the gaming location, and indicating a presence of at least one of the plurality of players on the map of the gaming location.

62. The system according to claim 59, wherein the at least one social networking function comprises:
a chat function;
a wild function;
a blogging function;
a player search function;
an opinion polling function;
a messaging function; and
a file sharing function.

63. The system according to claim 59, further comprising a component adapted to determine a location of the player based on an act performed by the player within the legal gaming location.

64. The system according to claim 63, further comprising a component adapted to determine, by the server-based gaming system, the location of the player based on the act which is performed at a terminal of the server-based gaming system.

65. The system according to claim 59, further comprising a component adapted to display, to the player at the terminal associated with the server-based gaming system, information shared among the plurality of players.

66. The system according to claim 59, further comprising a component adapted to provide, to the player at the terminal associated with the server-based gaming system, a control that permits the player to create a group of associations with other players.

67. The system according to claim 59, further comprising a component adapted to provide, to the player at the terminal associated with the server-based gaming system, a control that permits a player to search for other players based on a set of criteria provided by the player.

68. The system according to claim 59, further comprising a component adapted to provide, to the player at the terminal associated with the server-based gaming system, a control that permits at least two players to locate each other based on criteria provided by both of the at least two players.

69. The system according to claim 59, further comprising a component adapted to provide, to the player at the terminal associated with the server-based gaming system, an advertisement based on an action performed by the player responsive to the provided at least one social networking function.

70. The system according to claim 59, wherein the terminal associated with the server-based gaming system is adapted to accept a wager from the player to play a wagering game.

71. The system according to claim 59, further comprising a component adapted to compile information provided by players by the at least one social networking function, and presenting the compiled information to the player at the terminal associated with the server-based gaming system.

72. The system according to claim 59, further comprising a component adapted to present the information to a user of a computer system coupled to the server-based gaming system through a communication network.

73. The system according to claim 72, wherein the computer system comprises a general purpose computer system.

74. The system according to claim 59, wherein the legal gaming location includes a physical gaming location comprising at least one of:
a casino;
a racino;
a dog-racing track;
a horse-racing track;
a point-of-sale location;
a riverboat; and
a legal gaming site;
a lottery retailer;
an off-track betting facility;
a sports betting parlor; and
a parlor that offers amusements with prizes.

75. The system according to claim 59, further comprising a component adapted to qualify the player by the server-based gaming system, and providing the at least one social networking function responsive to the qualification.

76. The system according to claim 59, further comprising a component adapted to permit at least two players to make a wager with each other using the at least one social networking function.

77. The system according to claim 59, wherein the server-based gaming system is configured to arbitrate a wager between at least two players using the at least one social networking function.

78. The system according to claim 59, further comprising a component adapted to display the information relating to a plurality of players located at the legal gaming location during play of the at least one game by the player in the legal gaming location.

79. The system according to claim 59, further comprising a component adapted to provide, to the player at the terminal associated with the server-based gaming system, an advertisement based on an interaction between at least two players using the provided at least one social networking function.

80. The system according to claim 59, further comprising a component adapted to present, to at least one other player in another terminal associated with the server-based gaming system, a personal user profile of the player.

81. The system according to claim 60, wherein the personal user profile of the player includes content provided by the player, and wherein the method comprises displaying, to the at least one other player, the provided content.

82. The system according to claim 59, further comprising a component adapted to permit the player to selectively share the personal user profile with one or more other players.

83. The system according to claim 80, further comprising a component adapted to store, in the personal user profile of the player, one or more content items provided by the server-based gaming system.

84. The system according to claim 59, further comprising a component adapted to provide, at a computer system located outside of the legal gaming location, access to a social networking function that permits communication with a plurality of players in the legal gaming location.

85. The system according to claim 59, further comprising a component adapted to provide, at a computer system located outside of the legal gaming location, access to a social networking function that permits a person operating the computer system to view a status of the player located in the legal gaming location.

86. The system according to claim 59, further comprising a component adapted to permit the player and at least one other player to transfer items using the social networking tool.

87. The system according to claim 86, wherein the items include at least one of a group comprising credits, non-cashable credits, frequent player program points, and cash.
